(19) United States
(12) Patent Application Publication
(10) Pub. No.: US 2011/0238430 A1
(43) Pub. Date: Sep. 29, 2011

(54) Organization Optimization System and Method of Use Thereof

(75) Inventor: Mark Sikorski, Tucker, GA (US)

(73) Assignee: ProvidedPath Software, inc.

(21) Appl. No.: 13/154,956

(22) Filed: Jun. 7, 2011

Related U.S. Application Data
(63) Continuation-in-part of application No. 12/107,829, filed on Apr. 23, 2008, now abandoned.

(51) Int. Cl. G06Q 10/00

(52) U.S. Cl. 705/1.1

(57) ABSTRACT

A fully integrated organization optimization system installed on and running on a server, the organization optimization system having auditing and policy support that includes a document management component, a project management component, a role management component, an incident management component, and an email management component. Users of the system can seamlessly navigate between different components, and changes to one part of the system will automatically be propagated elsewhere as appropriate. Further, the system supports the implementation, redefinition and tracking of company policy, particularly with regards to compliance.

### CROSS-REFERENCE TO RELATED APPLICATIONS

The present application is a continuation-in-part of patent application Ser. No. 12/107,829, entitled “COMPUTER IMPLEMENTED SYSTEM AND METHOD FOR GOVERNANCE AND COMPLIANCE”, filed on Apr. 23, 2008, which is incorporated herein by reference, and claims priority thereto and the full benefit thereof, and the present application further claims priority to and the full benefit of U.S. Provisional Application Ser. No. 60/913,495, filed Apr. 23, 2007, which is incorporated herein by reference.

### FEDERALLY SPONSORED RESEARCH OR DEVELOPMENT

### None

### PARTIES TO A JOINT RESEARCH AGREEMENT

### None

### REFERENCE TO A SEQUENCE LISTING

### None

### BACKGROUND OF THE INVENTION

1. Technical Field of the Invention

The present invention relates generally to management systems, and more specifically to organization and document management systems with audit support functionality.

2. Description of Related Art

People within organizations learning from mistakes and developing ideals, institute systems of checks and balances known as controls to achieve effective governance. Governance seeks to increase efficiency, accuracy and financial gain, while minimizing risk. Appropriate management of information about controls, policies, processes, best practices, risks, assessments and evidentiary materials is vital. Auditing is the validation of these efforts to achieve and maintain ideals.

Auditing organizations frequently require their own checks and balances. Organizations use a variety of tools to document and manage their efforts to achieve and maintain ideals. The effect of conflicts of interest are guarded against as these tools are employed. Using a disparate set of tools and techniques with difficult to enforce user rights and privileges across loosely associated tools and efforts may cause a lack of efficiency and limit the ability to tie information to controls, documentation and other types of information and therefore to realize governance ideals.

Since the use of computers has become common, there has been a constant effort to utilize computers to increase efficiencies, validity of information and safety within organizations. Organizations also struggle to manage audits.

For document management systems, as the initial transition was made to utilizing computers, the typical approach was to utilize shared network drives. Users would create, edit and save documents on network drives and utilize folder structures to organize the documents. A limitation of this system is that it could be very difficult to manage sub-matters within a main matter, particularly if the characteristics of the sub-matters were constantly evolving. A further limitation is that if a document is misplaced in the folder structure, it is very time consuming to locate the misplaced file. Another limitation was that there was very little, if any, metadata generated about the documents, so searching for documents could be very time consuming. Furthermore, certain documents apply to multiple controls or sets of controls, and changes within these documents frequently are reflected across related controls. The sub folder approach negates efficiency.

Another attempt at document management systems involved a separate piece of software that managed and controlled how users find and save documents. In this approach, there was some additional metadata being saved about each document, mainly the main subject and a sub-subject. This made it somewhat easier for users to find documents; however, the previous problem remained of a user needing to find a document that related to a specific issue, task or control or group(s) of controls. Some of these systems provided integration with emails, but such integration was limited to being able to save and view emails within the system.

For organization management systems, an initial approach was to simply communicate tasks in the hope that the specified tasks would get done. Obviously, this approach had the limitation of very poor documentation and very limited assistance to the manager wishing to follow up on the task to make sure it was completed. It made auditing efforts equally as difficult.

Another organization management system approach was to construct organization charts, with the charts naming employees and the tasks they are responsible for. However, if the tasks are described generally, it can be unclear which specific tasks an employee is responsible for, and, if the tasks are described in detail then often the detailed description will shortly become outdated and therefore incorrect.

For audit management, companies generally struggle to implement systems that are both efficient and effective, and because of the importance of having effective auditing companies have generally sacrificed efficiency. Initially, companies generally approached audit management by simply sending auditors into the field to search for documents and pieces of information evidencing due diligence wherever they may have been located. Obviously, this method was grossly inefficient, but it should be noted that this method is still commonly utilized.

Another approach to audit management involved the company instructing employees to maintain logs and information. However, a limitation of this approach was that employees were inconsistent about updating the logs as the information became scattered about the organization and difficult to find and reference.

While many forms of governance and compliance are mandated, the underlying spirit of improving accuracy and efficiency while reducing risk is not achieved. Efforts put forth towards one form or governance and/or compliance are often duplicated elsewhere for other forms of governance and compliance.

Therefore, it is readily apparent that there is a need for a management system that incorporates organization management, document management, information management, audit preparation and audit management at a controls level.

### BRIEF SUMMARY OF THE INVENTION

Briefly described, in a preferred embodiment, the present invention overcomes the above-mentioned disadvantages and meets the recognized need for such a device by providing an integrated organization optimization system with support for auditing and policy management, which includes, among other elements, a navigation based training and help component, a resource management component, a project management component, a controls management component, a financial management component, a Gap management component, a document management component, a risk management component, a process automation component, a process improvement management component, a process and policy communications component, a controls training management component, an organization templates and forms management component, a controls testing management component, an evaluation management component, a laws and regulations management component, a role management component, an incident management component, a best practices management component, and an email management component. Users of the system can navigate between different components, and changes applied in one part of the system will automatically be propagated elsewhere as appropriate with most such information linked at the controls level. Further, the system supports the implementation, redefinition and tracking of the organization's processes and policies and their appropriate dissemination, particularly with regards to compliance.

According to its major aspects and broadly stated, the present invention in its preferred form is an organization optimization system that runs on a computer server. The organization management component has a user management component, the user management component having a plurality of user accounts, and each user account comprising a username and a password, and each user account is associated with a user.

The organization management component also has a login component, the login component being communicatively connected to the user management component. Users enter their username and user password into a computer that is communicatively connected to the server, and the user is allowed a session with the organization optimization system if the user provides the correct username and password.

The organization optimization system also has a project management component, the project management component being communicatively connected to the user management component. The project management component has at least one project, and the project has a phase, and the phase has a control, and the control has a task, and the task is assigned to a user.

The organization optimization system also has a navigation based training and help component, the navigation based training and help component being communicatively connected to the user management component. The navigation based training and help component has at least one training video, and at least one training topic, and the video is optionally made available to a user with content suitable for their role and dependant upon the intended navigation destination within the organization optimization system.

The organization optimization system has a document management component, the document management component being communicatively connected to the project management component and the user management component, and the document management component has at least one document.

The organization optimization system also has a role management component, the role management component being communicatively connected to the user management component, and the role management component having a plurality of roles, and users are preferably associated with at least one role.

The role management component has a system administrator role, and in its preferred embodiment if a user is associated with the system administrator role the user may only interact with the user management component. The role management component also has a read only role, and if a user is associated with the read only role then the user is restricted from changing anything in the organization optimization system. The role management component also has a SOX compliance officer role, and any user associated with the SOX compliance officer role has wide ranging access within the organization optimization system. The role management component also has a governance compliance officer role, and any user associated with the governance compliance officer role has wide ranging access within the organization optimization system.

The organization optimization system also has an email integration component, the email integration component being configured to enable a user in a session to generate email referencing a unique key, and a contact and email address listing from the organization management system is made available to the user. The unique key is representative of the user's session from anywhere in the organization management system. The unique key points to a table of information that contains information about the system state, e.g., current component, current role, current screen, and current record. The recipient of the email or users within appropriate roles may click a button in the email management component to be taken to the document, risk, test result, evaluation, or any other piece of information that the user has written them about in the email. By clicking a button, the recipient user is taken to the information pertaining to the content of the email with access rights and privileges that are appropriate to their role. Users may email self assessment surveys to others within the organization or others outside of the organization who are related to the organizations governance and compliance efforts. Responses to these surveys are tracked to the control level and control related meta data and this information is available to the ad-hoc reporting component. As emails are replied to or forwarded to others, the organization optimization system is copied and correspondence is tracked to the control level and control related meta data and this information is available to the ad-hoc reporting component. As emails are replied to or forwarded to others, the organization optimization system is copied and correspondence is able to be grouped and associated by key thereby comprising a chronological audit log for correspondence related to controls and control meta data.

The organization optimization system also has a digital signature component, the digital signature component having a digital signature, and the digital signature component is configurable to capture and store a digital signature when a user performs an action within the system that may invite the potential for fraud or deception and therefore may be subject to repudiation by the user and the digital signature component can also be configured to store a digital signature when a user edits or completes a task. When a digital signature is required the user re-authenticates via a pop-up dialogue box that appears as they attempt to save changes. Both successful digital signature captures and failed digital signature attempts are captured in appropriate audit logs throughout the system and are searchable, exportable and printable as a secure PDF. A user may access a project, a control, a phase, or a task or any other information in the system if the user has sufficient rights.

The organization optimization system also has an incident management component, the incident management component having at least one incident. A user can associate an incident with a risk, thereby associating it with a document and its corresponding control. The incident management component provides users in appropriate roles the ability to view and edit incident records that are associated with a control, a document, or a risk. When incidents are associated with risks, the dollar value of the incident is also associated with the risk therein assisting with the prioritization of risk mitigation efforts. By assessing risk against entities for organizations that are associated with the primary organization, enterprise risk management is accomplished. The risk management component allows for heat map filtering at the risk status level throughout the organization and all sub-organizations.

A user can post a stored document within the document component in a way that is accessible by users and whose content is appropriate to the entity the user is affiliated with and the role they play within the organization. The document may relate to training or educating a different user.

Tasks are assigned to a user, and the user to which the task is assigned is responsible for completing the task, and the user is responsible for editing the status of the task when the task is completed.

Tasks are assigned to a user, and the user to which the task is assigned is responsible for completing the task, and the user is responsible for updating time billing information for the task when the task is completed.

The project management component also has an audit log, the audit log being associated with a project, a control, a phase, a task, or a document, and the audit log contains a history of user activity on the project, the control, the phase, the task, or the document.

In an alternate embodiment, the present invention is an organization optimization system that runs on a server that is communicatively connected to a computer, and users utilize the computer to interact with the organization optimization system on the server. The organization optimization system has a user management component, the user management component having a plurality of users and passwords, and each user is associated with a password.

The organization optimization system also has a project management component and a document management component that are communicatively connected to the user management component. The document management component contains at least one document.

The organization optimization system further has a role management component and an email management component. The role management component has a plurality of roles, and users are associated with at least one role. The email management component provides users in a session the ability to generate email that reference(s) a unique key(s), and the unique key represents the user's session when the unique key was generated.

The organization optimization system also has a digital signature component, the digital signature component being configurable to store a digital signature when a user stores a document and/or stores a new version of a document, the digital signature being associated with the user. The user is assigned rights to the organization optimization system, and the user is granted access consistent with the assigned rights.

The project management component has at least one project, each project can have at least one phase, each phase can have at least one control, each control can have at least one task, each task being associated with a user.

The organization optimization system also has an incident management component, the incident management component having at least one incident, and users can associate incidents with a control, a document, or a risk. The incident management component provides users the ability to view and edit incidents that are associated with a control, a document, or a risk.

Each task is associated with and assigned to a user, and the user is responsible for completing the task and editing the status of the task and optionally, reporting time spent, when the user completes the task. The project management component also has an audit log, which is associated with a project, a control, a phase, a task, or a document. The audit log has a history of user activity with respect to the project, the control, the phase, the task, or the document.

More specifically, the present invention is an organization optimization system running on a server with data. The organization optimization system also has a login component, an interface and control component, a user management component, a document management component, a project management component, a role management component, an email management component, an options management component, a whistle blower management component, an incident management component, a navigation based training and help component, a policy posting component, a control training posting component, a financial management component, a controls management component, a risk management component, a control testing component, an evaluation component, a process automation component, a gap management component, a laws and regulations management component and a glossary management component. The interface and control component is in communication with the login component, user management component, controls management component, document management component, project management component, navigation based training and help component, role management component, email management component, options management component, whistle blower management component, incident management component, risk management component, policy posting component, controls training posting component, gap management component, control testing management component, evaluation component, laws and regulations management component and the glossary of unique terms management component.

In a preferred embodiment, the login component, interface and control component, user management component, document management component, project management component, role management component, email management component, options management component, whistle blower management component, incident management component, navigation based training and help component, risk management component, policy posting component, control training posting component, gap management component, controls management component, process automation management component, financial management component, laws and regulations management component and glossary management component are located on a server. In an alternate embodiment, the organization optimization system is located on a plurality of servers. Such an alternate embodiment would mitigate any technical problems that may affect the organization optimization system, including but not limited to an overburdened central processing unit (CPU), an overburdened network card, or insufficient hard drive space.

An access terminal is communicatively connected to a network via user communication, wherein the network is communicatively connected to the server. Alternatively, the access terminal is communicatively connected to the internet via user communication, and the internet is communicatively connected to the internal network via user communication, and the internal network is communicatively connected to the server via user communication. A user and a second user utilize an access terminal to communicate with the organization optimization system. In a preferred embodiment the access terminal and the server are computers.

The server also has data, data being information within the organization optimization system. A computer system is an additional computer communicatively connected to the server. Alternatively, the computer system is the same computer as the server. In its preferred embodiment, the access terminal comprises a document editor, wherein the document editor is software utilized by a user. The access terminal also delivers iconic representations.

The user management component has a user account and a user list. The user account has a username, user password, personal name, user title, assigned rights, assigned requirements, competency assessment, user status and user contact information and optionally a photograph. The user contact information is a phone number and a user email address, and each username is unique within the user management component, and user status is either “Active” or “Disabled”. In a preferred embodiment, the user management component has a plurality of user accounts, and the user list has a plurality of user accounts.

The document management component comprises a document, a document template, a SOX document, a governance document, a process automation, an improvement, a defined term, a policy training document, a control automation, document images, a new document, a new document version, a current documents list, a version list, a version number, a new version number, a risk management component, a control training posting component and a posted policy component. The posted policy component has a posting user. Documents, document templates, standard templates and forms, best practices documents, governance templates and policy training documents have a document type, and document types are any type of file that can be stored on a computer, including, for exemplary purposes only, a MICROSOFT Word document, a spreadsheet, including MICROSOFT Excel, a file that has been “zipped”, a movie, or computer program. An iconic representation may be associated with the document type. Documents, document templates, SOX documents, governance documents and control training documents each have a status, wherein the status is either “Active” or “Retired”. The text within a document being stored is captured and entered into a searchable field that is associated with the document. The risk management component has a risk, an audit log and audit information. A risk is at least one risk that may have adverse effects. In a preferred embodiment, a risk is defined by Committee of Sponsoring Organizations of the Treadway Commission (COSO) and/or Control Objectives for Information and Related Technology (COBIT) or another standards organization. An audit log is associated with a document, a project, a phase, a control or a task, and an audit log identifies the user account that has stored a new version of the document, or made changes to project(s), phase(s), control(s) or task(s).

The project management component has a project, project list, phase list, control list and task list. Each project has a project user visible, a project active and a phase, and each phase has a phase active and control. Each control has a control active and a task, and each task has a task active, task name, task owner, and task status. Project user visible, project active, phase active, control active and task active are each either “True” or “False”. Task due date is a calendar date, and task status is “Assigned”, “Begun”, “Waiting”, “Stalled” or “Performed”. The task owner identifies a user account.

The role management component comprises rights and requirements. Roles have rights and privileges, and assigned rights of a user account are associated with roles and/or requirements. The different roles are: system administrator role, process activity manager role, process activity supervisor role, audit committee role, read only role, executive role, SOX compliance role, SOX audit role, SOX tester role, SOX evaluator role, lead auditor role, governance preparation role, governance tester role and governance evaluator role. The different privileges are entity wide privileges and sub assignment privileges. The different requirements are competency requirement and notification requirement. Compliance competency is a field for the user.

The email management component has an email, a unique key and a send keyed email. The options management component has a digital signature, digital signature settings and an EPS management component. The digital signature settings have digital signature template storage, digital signature SOX document storage, digital signature governance document storage, digital signature process automation, digital signature activity management, digital signature activity supervision, digital signature edit company document, digital signature edit training document, digital signature glossary term, digital signature loss event management, digital signature risk management, digital signature risk mitigation, digital signature process entry update, digital signature process creation, digital signature deficiency creation, digital signature SOX control, digital signature governance control, digital signature competency acknowledgement, and digital signature competency updates, each of which comprise “Active” and “Disabled”. Digital signatures identify a user account. The EPS management component comprises an EPS job and an EPS job list. An EPS job has an EPS job name, an EPS job schedule, an EPS execution configuration and an EPS job priority.

An EPS job is a computer software script or program, and the EPS job is configured to, for exemplary purposes only, Get Email And Confirmations, Create Process Automation Notifications Email, Refresh Intranet Information, and/or Send Automatic Emails.

The Get Email And Confirmation job preferably includes receiving email from organization email servers that have been addressed to the organization optimization system. The job may also include matching unique keys found in the emails against key information found in system tables and making relational associations in the email management component at the control level, associating process automation completion notification and process automation supervision notifications with the process automation component and associating evidence of completion attachments with same in the email system. Associating confirmations of email receipt can be used for non-repudiation and reporting purposes. Incoming email correspondence is tracked to the control and control meta data level.

The Create Process Automation job preferably includes sending process automation notifications and supervision notifications and reminders following schedules defined within the process automation component of Process Automation. Email correspondence is tracked to the control level.

The Refresh Intranet information job preferably includes Updating contact information including photos of people these photos for exemplary purposes only, optionally being made available through the organization intranet for physical security purposes, updating terms that are unique to the organization, updating the posting of standard templates and forms for the organization, updating policy documents with newer versions or removing recently retired ones from posting, updating controls training documents with newer versions or removing recently retired ones from posting, retrieving questionnaire responses and matching them against optimal responses.

The Send Automatic Emails job preferably includes sending email notifications of changes in internal control to contacts labeled as Board of Directors/Audit Committee and Executive and/or users defined as requiring Change Notification, sending notifications of changes to controls to control owners, alternate control owners, process owners, and alternate process owners, sending emails containing gap remediation proposals to internal auditors, preparation auditors, external auditors and legal counsel for review, approval and/or suggested amendment. This job also sends project task due reminder emails to users. This job also sends competency assessment profile acknowledgement and/or update reminders to appropriate users. Email correspondence is tracked to the control level.

For exemplary purposes only, the EPS job schedule describes how often an EPS job is executed. The EPS execution configuration describes the sequence the jobs run in, and EPS execution configuration also describes which computer system the EPS job will run on. The EPS job priority describes the priority level of the EPS job when it runs on a computer system(s).

The whistle blower management component has a whistle blower event, a whistle blower event list, information and a questionnaire.

The incident management component has an incident, an incident association, an incident list, a risk and a control recommendation. An incident has an incident name, an incident description, an incident resolution, an incident cost and an incident status.

The navigation based training and help component has a training and help video, a role based user navigation destination in which the video is to be presented, a role appropriate training and help video, a user addressable switch to turn the component on or off, with the values being “True” or “False”.

The glossary management component has a glossary, a unique word and a word definition. Optionally, the glossary management component may also be populated with standard terms. An organization has at least one entity, and the entity may utilize the organization optimization system.

A user begins a session by accessing the server. The user subsequently enters his/her username and a user password, the username and user password being associated with his/her user account, and the user account is associated with the user. It is determined, by means of internal or external authentication, (1) if the username and user password are correct, and (2) if the user account is “Active”. If the username and user password are incorrect, or if the user account is “Disabled”, the session returns to login. If the username and user password are correct, and the user account is “Active”, the user proceeds to interact with the organization optimization system. Dependant upon the user's present role within the current session, interacting with the organization optimization system can include viewing, editing and/or creating data, including, for exemplary purposes only, viewing and/or editing user accounts, documents, risks, audit logs, projects, phases, controls, assessments, graphs tasks, emails, EPS jobs, whistle blower events, incidents, risks, unique words and/or word definitions. User activity is audit logged within the system. For exemplary purposes, all audit logs are searchable, printable, exportable and may be printed as a secure PDF. Access to audit log information is controlled by user role since audit logs are accessed via the various components of the system. When the user finishes interacting with the organization optimization system, the user is disconnected from the organization optimization system.

In a preferred embodiment, while the user is in a session, the user communicates with the interface and control component. The interface and control component communicates with the login component, user management component, navigation based training and help component, document management component, project management component, role management component, email management component, options management component, whistle blower management component, incident management component, glossary management component, risk management component, process automation component, process improvement component, financial management component, GAP management component, controls management component, policy posting component, training posting component, project dashboard, all reports component, best practices component, executive documents component, laws and regulations component, controls testing component, evaluation component, cost management component, user settings component, knowlegebase management component, resource management component and, subsequently, interface and control component resumes communicating with the user.

The user interacts with the organization optimization system. If a user chooses to interact with the user management component, then if the user has sufficient access rights, the user interacts with the user management component. If a user chooses to interact with the navigation based training and help component, then if the user has sufficient access rights, the user interacts with the navigation based training and help component. If a user chooses to interact with the document management component, then if the user has sufficient access rights, the user interacts with the document management component. If a user chooses to interact with the project management component, then if the user has sufficient access rights, the user interacts with the project management component. If a user chooses to interact with the options management component, then if the user has sufficient access rights, the user interacts with the options management component. If a user chooses to interact with the whistle blower management component, then if the user has sufficient access rights, the user interacts with the whistle blower management component. If a user chooses to interact with the incident management component, then if the user has sufficient access rights, the user interacts with the incident management component. If a user chooses to interact with the glossary management component, then if the user has sufficient access rights, the user interacts with the glossary management component. If a user chooses to interact with the risk management component, then if the user has sufficient access rights, the user interacts with the risk management component. If a user chooses to interact with the navigation based training and help component, then if the user has sufficient access rights, the user interacts with the navigation based training and help component. If a user chooses to interact with the process automation component, then if the user has sufficient access rights, the user interacts with the process automation component. If a user chooses to interact with the process improvement component, then if the user has sufficient access rights, the user interacts with the process improvement component. If a user chooses to interact with the financial management component, then if the user has sufficient access rights, the user interacts with the financial management component. If a user chooses to interact with the GAP management component, then if the user has sufficient access rights, the user interacts with the GAP management component. If a user chooses to interact with the controls management component, then if the user has sufficient access rights, the user interacts with the controls management component. If a user chooses to interact with the policy posting component, then if the user has sufficient access rights, the user interacts with the policy posting component. If a user chooses to interact with the training posting component, then if the user has sufficient access rights, the user interacts with the training posting component. If a user chooses to interact with the project dashboard, then if the user has sufficient access rights, the user interacts with the project dashboard component. If a user chooses to interact with the all reports component, then if the user has sufficient access rights, the user interacts with the all reports component. If a user chooses to interact with the best practices component then if the user has sufficient access rights, the user interacts with the best practices component. If a user chooses to interact with the executive documents component, then if the user has sufficient access rights, the user interacts with the executive documents component. If a user chooses to interact with the laws and regulations component, then if the user has sufficient access rights, the user interacts with the laws and regulations component. If a user chooses to interact with the controls testing component, then if the user has sufficient access rights, the user interacts with the controls testing component. If a user chooses to interact with the evaluation component, then if the user has sufficient access rights, the user interacts with the evaluation component. If a user chooses to interact with the cost management component, then if the user has sufficient access rights, the user interacts with the cost management component. If a user chooses to interact with the user settings component, then if the user has sufficient access rights, the user interacts with the user settings component. If a user chooses to interact with the knowledgebase management component, then if the user has sufficient access rights, the user interacts with the knowledgebase management component. If a user chooses to interact with the resource management component, then if the user has sufficient access rights, the user interacts with the resource management component. If a user chooses to interact with the laws and regulations management component, then if the user has sufficient access rights, the user interacts with the laws and regulations management component.

While interacting with the user management component, the user views a user account and the user list, and the user can send an email. If the user wants to create a user account and the user has sufficient assigned rights, then the user can create a user account and can send an email. If the user wants to edit a user account and the user has sufficient assigned rights, then the user edits a user account and can send an email.

While interacting with the document management component a user can, if the user has sufficient assigned rights, send an email and view the current document list, the current document list preferably having at least one document. A user can also, if the user has sufficient assigned rights, send an email and view the version list, the version list preferably having at least one version number and/or at least one new version number associated with a document.

A user can also, if the user has sufficient assigned rights, optionally send an email and record a risk, recording a risk consisting of associating a risk with a document or a control. If a user has sufficient assigned rights, then the user can optionally send an email and set a process automation, setting a process automation consisting of associating a document with a task. For example, if a company is required to pay insurance premiums, the process or procedure for paying insurance premiums is defined within a document and would be defined as a task. The process automation name would be defined, the activity manager would be assigned, an activity description would be entered, the repeat interval would be set with for exemplary purposes values being: hourly, daily, weekly, bi-weekly, monthly, quarterly semi-annually, bi-annually. Also defined: begin date with date being a calendar date, end date with date being a calendar date, daily begin time with time being an hour of the day, daily end time with time being an hour of the day, include weekends with “true” or “false” being values, an activity supervisor is assigned, number of days before emailing supervisor for follow up after notification with number being a number and with a default number set or not set.

If a user has sufficient assigned rights, then the user can optionally send an email and suggest an improvement, where an improvement consists of associating an improvement with a document that describes a process or policy that may be improved. For example, an improvement may be related to the creation of a new task, a control, a phase or a project.

A user can also, if the user has sufficient assigned rights, optionally send an email and post a policy training document relating to a control or training a user or persons appropriately related to the organization. If a user has sufficient assigned rights, then the user can send an email and edit a document with a document editor.

If a user has sufficient assigned rights, then the user can also send an email and activate a control automation, a control automation consisting of changing the status of a document, a task, a control, a phase and/or a project from “Disabled” to “Active”. A user can also, if the user has sufficient assigned rights, send an email and view document images, in a preferred embodiment, document images being iconic representations of the document type of at least one document. If a user has sufficient assigned rights, then the user can optionally send an email to correspond with counterparts and generate a new document by creating and saving a new document in the document management component.

A user can also, if the user has sufficient assigned rights, send an email and generate a new document version wherein the user associates a document with a new version number. If a user has sufficient assigned rights, then the user can send an email and view a document, wherein viewing a document consists of the user viewing at least one document with a document editor. A user can also, if the user has sufficient assigned rights, send an email and export a document, exporting a document meaning saving a document outside of the document management component.

The risk management component appends audit information to an audit log, the audit log being associated with a document that a risk is being associated with, and the audit information is associated with the user doing the association. The audit log may or may not contain digital signature capture information preferably depending upon the digital signature capture setting and/or if the re-authentication was successful. The risk management component also appends audit information to an audit log, the audit log being associated with a document or a task, and the audit information is associated with the user viewing and/or editing the document or task. The risk management component also appends audit information to an audit log, the audit log being associated with a document that an improvement is being associated with, and the audit information being associated with the user doing the association. The risk management component also appends audit information to an audit log, wherein the audit log is associated with a document that is being posted, and the audit information is associated with the user doing the posting. The risk management component also appends audit information to an audit log, the audit log being associated with a document that is being edited, and the audit information is associated with the user doing the editing. The risk management component also appends audit information to an audit log, the audit log being associated with a document that is being generated, and the audit information is associated with the user doing the generating. The risk management component also appends audit information to an audit log, the audit log being associated with a document for which a new version number is being created, and the audit information is associated with the user creating the new version of the document. The risk management component appends audit information to an audit log, wherein the audit log is associated with a project that is being edited, and the audit information is associated with the user editing the project. The risk management component also appends audit information to an audit log, the audit log being associated with a phase that is being edited, and the audit information being associated with the user editing the phase. The risk management component appends audit information to an audit log, the audit log being associated with a control that is being edited, and the audit information is associated with the user editing the control. The risk management component also appends audit information to an audit log, the audit log being associated with a task that is being edited, and the audit information is associated with the user editing the task.

If a user has sufficient assigned rights, then the user can optionally send an email and view a project list having every project in the project management component, if visibility to the project(s) has been granted to the user, if the user has assigned rights sufficient to see projects in the project list, and if projects in the project list have its project user visible and project active set as “True”. If a user has sufficient assigned rights, the user can, after selecting a project, send an email, edit the project and view the phase list, the phase list having phases in the project, and phases in the project have their phase active set as “True”. If a user has sufficient assigned rights, the user can, after selecting a phase, send an email, edit the phase and view the control list, the control list having controls in the phase, and controls in the phase have their control active set as “True”. If a user has sufficient assigned rights, the user can, after selecting a control, send an email, edit the control and view the task list, the task list having tasks in the control, and tasks in the control have their task active set as “True”. If a user has sufficient assigned rights, the user can send an email and edit a task's properties, including its task active, task name, task owner, task due date and task status.

A user interacting with the options management component may interact with the EPS management component provided that the user has sufficient assigned rights. A user interacting with the options management component may interact with the organizations management provided that the user has sufficient assigned rights. A user interacting with the options management component may interact with the entities management provided that the user has sufficient assigned rights. A user interacting with the options management component may interact with the contacts management provided that the user has sufficient assigned rights. A user interacting with the options management component may interact with the systems settings provided that the user has sufficient assigned rights. A user interacting with the options management component may interact with the systems settings by changing the Forbid Users From Making Changes To The Status Of A Task After Having Indicated That The Task Has Been Completed from “True” to “False” or from “False” to “True”. A user interacting with the options management component may interact with the systems settings by changing the Force Users To Update The Status Of Each Task Upon Exiting The Workflow from “True” to “False” or from “False” to “True”. A user interacting with the options management component may interact with the systems settings by changing the Use Internal Authentication Instead Of External Authentication. from “True” to “False” or from “False” to “True”. A user interacting with the options management component may interact with the systems settings by changing the Enable Email Creation Capability For Deadline Approaching Or Deadline Passed Button from “True” to “False” or from “False” to “True”. A user interacting with the options management component may interact with the set email option menu provided that the user has sufficient assigned rights. A user interacting with the options management component may interact with the set email receiving settings provided that the user has sufficient assigned rights. A user interacting with the options management component may interact with the set email sending settings provided that the user has sufficient assigned rights.

Otherwise, while interacting with the options management component, a user can view the digital signature settings, and, if the user has sufficient assigned rights, the user can edit the digital signature settings, which includes changing one of the following to either “Active” or “Disabled”: digital signature template storage, digital signature SOX document storage, digital signature governance document storage, digital signature process automation, digital signature activity management, digital signature activity supervision, digital signature edit company document, digital signature edit training document, digital signature glossary term, digital signature loss event management, digital signature risk management, digital signature risk mitigation, digital signature process entry update, digital signature process creation, digital signature deficiency creation, digital signature SOX control, digital signature governance control, digital signature competency acknowledgement and/or digital signature competency updates. While interacting with the EPS management component, a user can optionally collaborate with others by sending an email and viewing the EPS job list. If a user has sufficient assigned rights, the user can send an email and retire an EPS job.

While interacting with the whistle blower management component, a user can optionally send an email and view the whistle blower event list. After selecting a whistle blower event, a user can, if the user has sufficient assigned rights, send an email and view the whistle blower event. If a user has sufficient assigned rights, then the user can send an email and change the status of a whistle blower event.

While interacting with the whistle blower management component, a user can optionally send an email and view the whistle blower event list. After selecting a whistle blower event, a user can, if the user has sufficient assigned rights, send an email and view the whistle blower event. If a user has sufficient assigned rights, then the user can send an email and change the status of a whistle blower event record.

A person related to governance and compliance efforts is asked questions within a questionnaire by the whistle blower management component on an intranet or an external site. The user provides information in an answer to the questionnaire, and, depending on the information the user provided, the whistle blower management component determines whether to create a whistle blower event record.

While interacting with the incident management component, a user can optionally send an email and view the incident list. After selecting an incident, if the user has sufficient assigned rights, the user can view the incident and send an email. If the user has sufficient assigned rights, the user can send an email and edit and/or update the status of the incident. Further, if the user has sufficient assigned rights, then the user can send an email and associate the incident with a risk, a document, or a control. If a user has sufficient assigned rights, the user can recommend an additional control or controls.

While interacting with the glossary management component, a user can, if the user has sufficient assigned rights, add, edit or retire a unique word and an associated word definition to the glossary management component.

In its preferred embodiment, two main menu bars are available for users within the organization optimization system. Users in either the SOX compliance officer or the Lead Internal Auditor Or Proxy have access to a superuser main menu bar. Other users have access to a stakeholder main menu bar.

The superuser main menu bar contains: a switch to set Navigation Based Training and Help to “True” or “False”. It also contains read only access to a Personnel listing, unique terms, as well as research and reference. Further this menu provides access to reports containing access to records for documentation and document notes including: internal control change notes and notable change notes, Process Automation Activities, Process Automation Notifications And Dispositions that the user has the ability to stamp as completed in behalf of Process Activity Manager or supervised in behalf of the Process Activity Supervisor, Intranet Postings Of Documents with the ability to activate or retire existing postings, and/or post new documents. Intranet Postings Of Controls Training has the ability to activate, retire, or post new training documents. Unique Glossary Terms has the ability to activate, retire, or add new terms per the selected document in the document management interface. Risk Management has the ability to change the disposition of risks and can recommend mitigation controls for the user to add new risks per the selected document in the document management interface. Incident Management has the ability to associate or re-associate risks with incidents and has the ability to add new incidents and change the disposition of existing ones. Process Improvement has the ability to change the disposition of records and recommend process improvement controls. Templates and Forms has the ability to store new templates and forms, and replace existing versions. Emails: users in this role can view emails for entities. Using the MGMT only menu, users in this role can also associate or re-associate emails with controls, and can access Whistle Blowing Incidents with write access to this module to change disposition of the status of records and provide the ability to access trending graphs and disposition pie charts. Users in this role have the ability to recommend new controls based upon information obtained from this module. A user in the role can access Competency Assessments with read only access due to records update being performed by other users who are required to update their current status on a regular interval. A user in this role has access to Control Testing and can add new documents and update existing ones with newer versions. A user in this role has access to Auditing Risks and access to Gap Management with full read/write access to records. The user can also access the Control Due Diligence Report. The superuser menu also contains management functions of: Email Association and Re-Association, Assign Project Tasks, store and update, activate or retire Best Practices for the internal control department or internal auditing of best practices depending upon role, and has the same rights for Templates Management for the management of company document templates and forms which includes the ability to add new documents and replace existing ones with newer versions, retire or activate existing documents, and may use the Features button to grant user access to view features videos, and may employ the use of Change Role to change their user role to any of the roles that are available to the user as defined in the role management component.

The stakeholder main menu bar includes: Training, Additional Modules of Personnel listing, Glossary, Research and Reference, Best Practices Management with read only access to internal control department or internal audit department best practices dependant upon role, organization templates and forms, emails that are sent by or received by themselves. Users in this role can view emails for others within their entity if their Entity Wide Access box checked is “True” within the role management component. Users can View Features movies and select other roles from a pull down list.

In its preferred embodiment, users in a System Administrator role have access to the stakeholder main menu bar and are able to enter information about organizations and classify said organizations. Available organization classifications are: Main Organization, Subsidiary of Parent Organization, Audit Preparation Firm, External Auditor, Acquisition Prospect and Legal Counsel. Entities are sub classifications of said organizations.

Users in a System Administrator role are able to associate available roles with users within the role management component. The list of available roles to be associated is determined and defined by the organization that any particular user is associated with. System Administrators associate roles with users based upon the functions that the users are qualified for and will be performing within governance and compliance efforts. The system ensures separation of duties through its project management component by ensuring that users are not able to be assigned tasks that are contradictory to tasks they performed in other roles by checking against previous activities on a control by control basis. By use of navigation mapping tables, read/write access tables and coding the system enforces user access right, permissions and privileges within components and determines which components any user within any given role is able to access.

Available roles for users in Main Organization are: System Administrator, Process Activity Manager, Process Activity Supervisor, Board of Directors/Audit Committee, Read Only Viewer, Executive, SOX Compliance Office or Proxy, SOX Audit Preparation/Remediation, SOX Control Tester, SOX Control Evaluation, Lead Internal Auditor Or Proxy, Governance Preparation/Remediation, Governance Control Tester and Governance Control Evaluator. Require options include: competency assessment and change notification. Project Management Privileges options include: entity wide info access and task sub-assignment.

In a preferred embodiment, available roles for users in Subsidiary of Parent Organization are: System Administrator, Process Activity Manager, Process Activity Supervisor, Board of Directors/Audit Committee, Read Only Viewer, Executive, SOX Compliance Office or Proxy, SOX Audit Preparation/Remediation, SOX Control Tester, SOX Control Evaluation, Lead Internal Auditor Or Proxy, Governance Preparation/Remediation, Governance Control Tester and Governance Control Evaluator. Require options include: competency assessment and change notification. Project Management Privileges options include: entity wide info access and task sub-assignment.

In a preferred embodiment, available roles for users in Audit Preparation Firm organizations are: Process Activity Manager, Process Activity Supervisor, Read Only Viewer, SOX Compliance Office or Proxy, SOX Audit Preparation/Remediation, SOX Control Tester, SOX Control Evaluation, Lead Internal Auditor Or Proxy, Governance Preparation/Remediation, Governance Control Tester and Governance Control Evaluator. Require options include: competency assessment and change notification. Project Management Privileges options include: entity wide info access and task sub-assignment.

In a preferred embodiment, the roles available for external auditors are: Process Activity Manager, Process Activity Supervisor, Read Only Viewer. Require options include change notification only. Project Management Privileges options include: entity wide info access and task sub-assignment.

In a preferred embodiment, available roles for users in Acquisition Prospect organizations are: Process Activity Manager, Process Activity Supervisor, Read Only Viewer, SOX Audit Preparation/Remediation, SOX Control Tester, SOX Control Evaluation, Governance Preparation/Remediation, Governance Control Tester, Governance Control Evaluator. Require options include: competency assessment and change notification. Project Management Privileges options include: entity wide info access and task sub-assignment.

In a preferred embodiment, available roles for users in Legal Counsel organizations are: Process Activity Manager, Process Activity Supervisor, Board of Directors/Audit Committee, Read Only Viewer, Executive, and Change Notification. Require options includes: competency assessment and change notification.

If a user has assigned rights of the system administrator role, the user interacting with organization optimization system can access and make changes to the user management component, the role management component, the options management component, the system settings, the digital signature management settings, the executive document types designations, the options settings, the email options settings, the email receiving settings, the email sending settings and the configure EPS settings. Users in this role have access to emails that are captured by the organization optimization system that they have sent or received.

Users in SOX Compliance Officer Or Proxy or the Lead Internal Auditor Or Proxy roles have access to control information and are able to designate controls as pertaining to SOX, Governance or Both in the control management component. This distinction is being made since evaluation requirements are vastly different between SOX auditing and other forms of auditing. By labeling controls in this way, users in evaluation roles are presented with evaluation interfaces and information that are appropriate to the requirements that they fulfill. Users in control testing roles are presented with information is appropriate for their role.

Users in evaluation roles are able to view read only information from previous evaluations to assist them with their assessments. Information within the evaluation component can be locked so it cannot be changed.

These users are also able to assess audit risk at a controls level during the evaluation, the results of which showing risk patterns within control sets, control areas, significant processes and other metadata associated at the control level within the controls management component.

Controls are labeled with a control number, significant account and/or governance area, significant process, control objective number, control objective, control risk number, control risk, control activity or element number, control activity or element, frequency, key control, fraud prevention or detection, IT dept or manual control, Preventative or detective control, associated with a control owner, an alternate control owner, a process owner, an alternate process owner, a custom control type and “True” or “False” can be applied to notify the control owner, alternate control owner, process owner, of any changes to the control via an email notification that is automatically generated by the system. Multiple wild cards may be designated, defined and searched upon and a unique name given to each wild card type. An audit log is available for changes within each control record. Controls can be added to the GAP component by “True” or “False” from within the controls component.

Within the Controls Management Component, controls are: associated with entities and can be cloned for other entities, exported to and imported from other systems, and exported as a template in industry standard formats using standard delimiters, importable from spreadsheets, importable from the knowledgebase component.

Relational links between the controls component and other components in the system ensure that records are filterable within superuser menu accessible reports and within ad hoc reporting capabilities contained within each component. These ad hoc reporting capabilities fully exploit use of the metadata that is associated with each control in the controls component. In a preferred embodiment, a control is deletable from the controls management component up until the first instance of any data being associated with that control within any component outside of the controls component.

Users in SOX Compliance Officer Or Proxy or the Lead Internal Auditor Or Proxy roles are able to define internal control structures for the organization within the controls component and define tasks for users against the controls in the controls component.

Users select from a pull down list of their available roles (this pull down list is available from at the top of the screen). They are then presented with a list of the tasks that they have been assigned. These tasks may be manual or may involve the use of other systems. If necessary, users enter the system workflow area by clicking on one of the tasks within the list and view the control information which includes: the Description Of The Control Objective, Control Activity/Element, Control Risk, Control Use, Control Source, Control Frequency, Significant Account Area, Significant Process, Process Owner, Preventative Or Detective Control, Fraud Prevention Or Detection, IT Department Or Manual. Users may optionally send an email to request clarification or collaborate with others regarding the control. Users may optionally view information about the source of the control by viewing it in the context in which it was written. PDF versions of the control source are made available to the user within the view control source component.

Components of the system are relationally linked to the controls component and components are synchronized to the same control as the task the user selected prior to entering the workflow area.

If a user has assigned rights of process activity manager role they have access to the stakeholder main menu. The user interacting with the organization optimization system can access the process automation component, and the user can access a process automation task for which the user is responsible and, may indicate that it has been completed and optionally, add completion notes and/or attach evidentiary materials.

If a user has assigned rights of process activity supervisor role, they have access to the stakeholder main menu. The user interacting with the organization optimization system can access the process automation component, and the user can access a process automation task for which the user is responsible and, may indicate that its correct completion has been supervised and optionally, add supervision notes.

If a user has assigned rights of board of directors/audit committee role, the user will receive an email if a document is stored or edited, the document relating to a change in internal control.

If a user has assigned rights of executive role, the user can view executive dashboards and they have access to the stakeholder main menu with an extra button for management of their separate document storage area in which they can store documents and update versions of those documents. An executive has read only access to: their task list, process automation component, document management, risk management, process management, unique terms, policy posting and training posting. The user does not have access to: project management component, user management component, controls management, gap management, time billing, risk mitigation control recommendation, process improvement controls recommendation, control testing, SOX evaluation, governance evaluation and within emails component they preferably cannot read emails other than ones they sent or received.

If a user has assigned rights of governance evaluator role, the user has unrestricted access to emails, the user management component and the glossary management component, and the user has read and write access to the document management component and the project management component.

If a user has assigned rights of entity wide privileges, the user has unrestricted access to documents, emails, projects, phases, controls, tasks, in so far as each of them are associated with the entity the user works in.

If a user has assigned rights of sub assignment privileges, then, if the user is the task owner of a task, the user can change the task owner of that task.

If a user has assigned requirements of competency requirement, then the user will be audited by a second user. If a user has assigned requirements of notification requirement, then the user will receive an email when a document is added, edited or deleted, the document being associated with a control.

When the organization management system audits a user, the organization management system selects a user and then determines if the user has the assigned requirements of competency requirement. If so, the organization management system either performs an audit or selects a different user.

If a user has assigned requirements of notification requirement, then the organization management system will send the user an email if a document, a task, a control, a phase or a project is associated with a control.

When a user sends an email, the email has a unique key. The unique key is associated with the session the user is in, and any user may utilize the unique key to navigate to the session state when the unique key was generated. For example, if a user generates a unique key while editing a document, when any user later utilizes the unique key then the organization optimization system will navigate the session back to that same document. In another example, if a user generates a unique key while viewing a task in a project, when any user later utilizes that unique key then the organization optimization system will navigate the session back to viewing that same task. In yet another example, if a user generates a unique key while viewing an incident in the incident management component, when any user with appropriate access privilege later utilizes that unique key then the organization optimization system will navigate the session back to viewing that same incident in the incident management component. In a preferred embodiment, the organization optimization system always provides the ability to send an email with a unique key.

If the digital signature SOX document storage is “Active”, then the organization optimization system stores a digital signature when a user edits, creates, deletes or replaces a SOX document and successfully re-authenticates.

If the digital signature governance document storage is “Active”, then the organization optimization system will store a digital signature when a user edits, creates, deletes or replaces a governance document and successfully re-authenticates.

If the digital signature process automation is “Active”, then the organization optimization system will store a digital signature when a user sets or updates a process automation and successfully re-authenticates.

If the digital signature activity management is “Active”, then the organization optimization system will store a digital signature when a user changes a task status to “Completed” and successfully re-authenticates.

If the digital signature activity supervision is “Active”, then the organization optimization system will store a digital signature when a user attests to the proper completion of the task and successfully re-authenticates.

If the digital signature edit company document is “Active”, then the organization optimization system will store a digital signature when a user edits, creates or deletes a document.

If the digital signature edit training document is “Active”, then the organization optimization system will store a digital signature when a user edits, creates or deletes a document, the document being associated with training a user.

If the digital signature glossary term is “Active”, then the organization optimization system will store a digital signature when a user edits, creates, deletes or retires a unique word, a non-unique word or word definition and successfully re-authenticates.

If the digital signature loss event management is “Active”, then the organization optimization system will store a digital signature when a user performs data entry, updates data, and/or makes an incident association with a risk and successfully re-authenticates.

If the digital signature risk management is “Active”, then the organization optimization system will store a digital signature when a user records or updates a risk and successfully re-authenticates.

If the digital signature risk mitigation is “Active”, then the organization optimization system will store a digital signature when a user creates a risk mitigation control recommendation and successfully re-authenticates.

If the digital signature process entry update is “Active”, then the organization optimization system will store a digital signature when a user records a process improvement suggestion and successfully re-authenticates.

If the digital signature process creation is “Active”, then the organization optimization system will store a digital signature when a user recommends a control to improve a process and successfully re-authenticates.

If the digital signature deficiency creation is “Active”, then the organization optimization system will store a digital signature when a user recommends a control to remediate a deficiency and/or mitigate a risk and successfully re-authenticates.

If the digital signature SOX control is “Active”, then the organization optimization system will store a digital signature when activity is SOX related and user generates or stores a new control test template document, a new control test, a new document version of an existing document, or if a user views or edits an existing control testing related document within the control testing component and successfully re-authenticates.

If the digital signature Governance Control Test Storage & Updating is “Active”, then the organization optimization system will store a digital signature when activity is governance related and a user generates or stores a new control test template document, a new control test, a new document version of an existing document, or if a user views or edits an existing control testing related document within the control testing component and successfully re-authenticates.

If the digital signature competency acknowledgement or the digital signature competency updates is “Active”, then the organization optimization system will store a digital signature when a user acknowledges that their then current a competency profile is accurate and successfully re-authenticates.

If the digital signature Competency Assessment Profile Updates or the digital signature Competency Assessment Profile Updates is “Active”, then the organization optimization system will store a digital signature when a user updates their competency assessment profile.

In a preferred embodiment, nothing is deleted from the organization optimization system, it is merely made inactive or retired, and therefore inaccessible to users in certain roles. Alternatively, data may be deleted at an interval consistent with compliance record keeping requirements.

Accordingly, a feature and advantage of the present invention is its ability to provide an easily manageable organization and project management system.

Another feature and advantage of the present invention is its ability to provide a project management system that allows for projects, phases, control associations and tasks to be selectively cloned. This operation capability allows for a subset of project information and associated data to be carried forward in sub-projects that may be scheduled at intervals that are consistent with required control area and control audit preparation and auditing.

Another feature and advantage of the present invention is its ability to provide an audit management system that does not sacrifice efficiency for effectiveness.

Still another feature and advantage of the present invention is its ability to provide a document management system that is intrinsically linked to an organization optimization system, an audit management system and an email integration component.

Yet another feature and advantage of the present invention is its ability to provide a proactive audit compliance system.

Yet still another feature and advantage of the present invention is its ability to provide a risk management component that is fully integrated in the organization optimization system.

Yet still another feature and advantage of the present invention is its ability to assist with Sarbanes-Oxley (SOX) compliance.

Yet still another feature and advantage of the present invention is its ability to manage concurrent and overlapping governance and compliance efforts efficiently.

Yet still another feature and advantage of the present invention is its ability to manage forms of governance and compliance efforts by appropriately tagging the requisite controls.

Yet still another feature and advantage of the present invention is its ability to repeat components of projects while carrying forth information from previous efforts.

Yet still another feature and advantage of the present invention is its ability to provide a universal interface to control automation technologies through its email capabilities.

Yet still another feature and advantage of the present invention is its ability to enforce user access rights role without the intervention of the IT department.

Yet still another feature and advantage of the present invention is its ability to link control related information.

Yet still another feature and advantage of the present invention is its ability to decrease evaluation efforts by allowing the re-use of previous evaluations for a different standard.

Yet still another feature and advantage of the present invention is its ability to track control related correspondence with parties that are external to the organization.

Yet still another feature and advantage of the present invention is its ability to realize a business advantage from achieving and maintaining compliance.

Yet still another feature and advantage of the present invention is its ability to retain best practices information from previous auditors that assists with the interpretation of previous evaluation results.

Yet still another feature and advantage of the present invention is its ability to allow for complex queries of information.

Yet still another feature and advantage of the present invention is its ability to help organizations understand which risks are costing them the most money, know where to go to find the related processes and policies that require adjustment, communicate changes and provide instruction.

Yet still another feature and advantage of the present invention is its ability to provide auditable information about the origin of change requests.

Yet still another feature and advantage of the present invention is its ability to minimize fraud, embezzlement and deception.

Yet still another feature and advantage of the present invention is its ability to ensure that only current processes, policies and training are made available.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a schematic view of the typical method of accessing and interacting with the organization optimization system, according to a preferred embodiment;

FIG. 2 is a schematic view of an alternate method of accessing and interacting with the organization optimization system, according to a preferred embodiment;

FIG. 3 is a schematic view depicting interaction of the various components of the organization optimization system, according to a preferred embodiment;

FIG. 4 is a flowchart depicting the basic stages of a session of use of the organization optimization system, according to a preferred embodiment;

FIG. 5 is a screen shot of an exemplary interface screen provided by the user management component, according to a preferred embodiment;

FIG. 6 is a screen shot of an exemplary interface screen provided by the document management component, according to a preferred embodiment;

FIG. 7 is a screen shot of an exemplary interface screen provided by the options management component, according to a preferred embodiment;

FIG. 8 is a screen shot of an exemplary interface screen provided by the EPS management component, according to a preferred embodiment;

FIG. 9 is a screen shot of an exemplary interface screen provided by the incident management component, according to a preferred embodiment;

FIG. 10 is a screen shot of an exemplary interface screen provided by the whistle blower management component, according to a preferred embodiment;

FIG. 11 is a screen shot of an exemplary interface screen provided by the project management component, according to a preferred embodiment;

FIG. 12 is a screen shot of another exemplary interface screen provided by the project management component, according to a preferred embodiment;

FIG. 13 is a screen shot of an exemplary interface screen provided by the user management component, focusing on the roles comprised in the role management component, according to a preferred embodiment;

FIG. 14 is a diagram depicting a corporation that comprises an entity, according to a preferred embodiment;

FIG. 15 is a diagram depicting the components in the glossary management component, according to a preferred embodiment;

FIG. 16 is a diagram depicting the components of a document, according to a preferred embodiment;

FIG. 17 is a flowchart showing the basic choices a user makes when interacting with the organizational management system, according to a preferred embodiment;

FIG. 18 is a flowchart depicting the steps of interacting with the user management component, according to a preferred embodiment;

FIG. 19 is a flowchart depicting selected steps available when interacting with the document management component, according to a preferred embodiment;

FIG. 20 is a flowchart showing other steps available when interacting with the document management component, according to a preferred embodiment;

FIG. 21 is a flowchart showing selected steps available when interacting with the project management component, according to a preferred embodiment;

FIG. 22 is a flowchart showing other steps available when interacting with the project management component, according to a preferred embodiment;

FIG. 23 is a flowchart depicting the steps available when interacting with the options management component, according to a preferred embodiment;

FIG. 24 is a flowchart showing the steps available when interacting with the EPS management component, according to a preferred embodiment;

FIG. 25 is a flowchart depicting the steps available when interacting with the whistle blower management component, according to a preferred embodiment;

FIG. 26 is a flowchart depicting the steps that occur when a user is given a questionnaire and a whistle blower event is selectively created, according to a preferred embodiment;

FIG. 27 is a flowchart showing the steps of a user interacting with the incident management component, according to a preferred embodiment;

FIG. 28 is a flowchart showing the steps of a user interacting with the glossary management component, according to a preferred embodiment;

FIG. 29 is a flowchart depicting the steps of a user being given a competency assessment, according to a preferred embodiment;

FIG. 30 is a flowchart showing the steps of a user interacting with the interface and control component, and the interface and control component interacting with other components, according to a preferred embodiment; and

FIG. 31 is a schematic view depicting the organization optimization system, according to a preferred embodiment.

### DETAILED DESCRIPTION OF THE PREFERRED AND SELECTED ALTERNATE EMBODIMENTS OF THE INVENTION

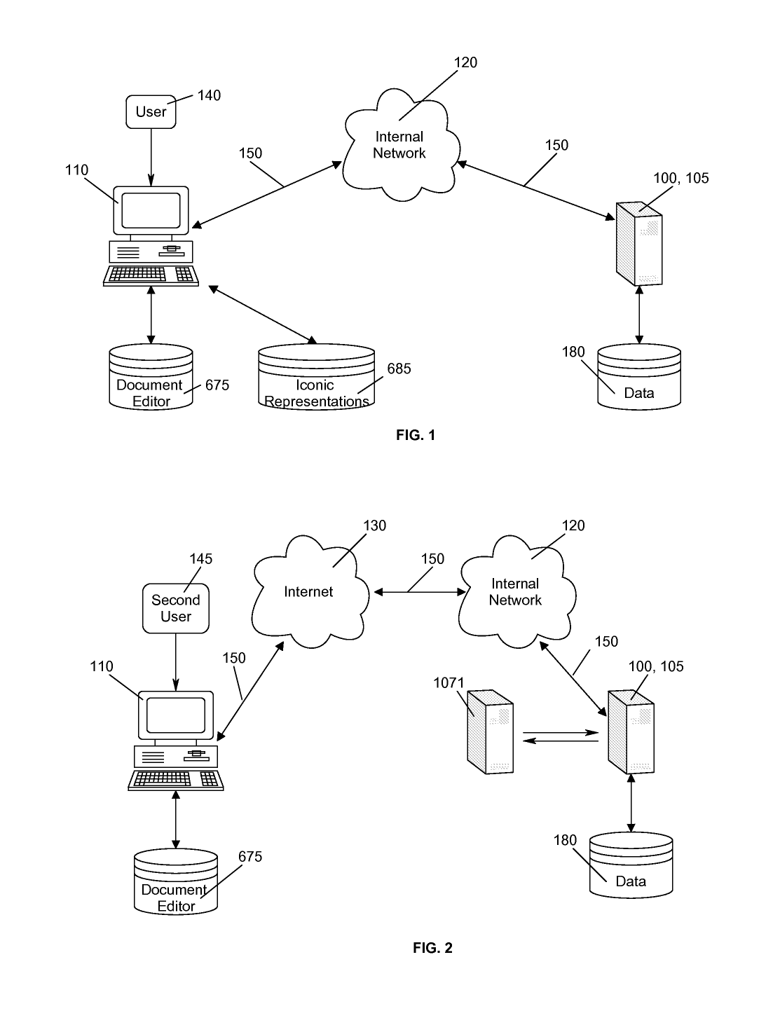

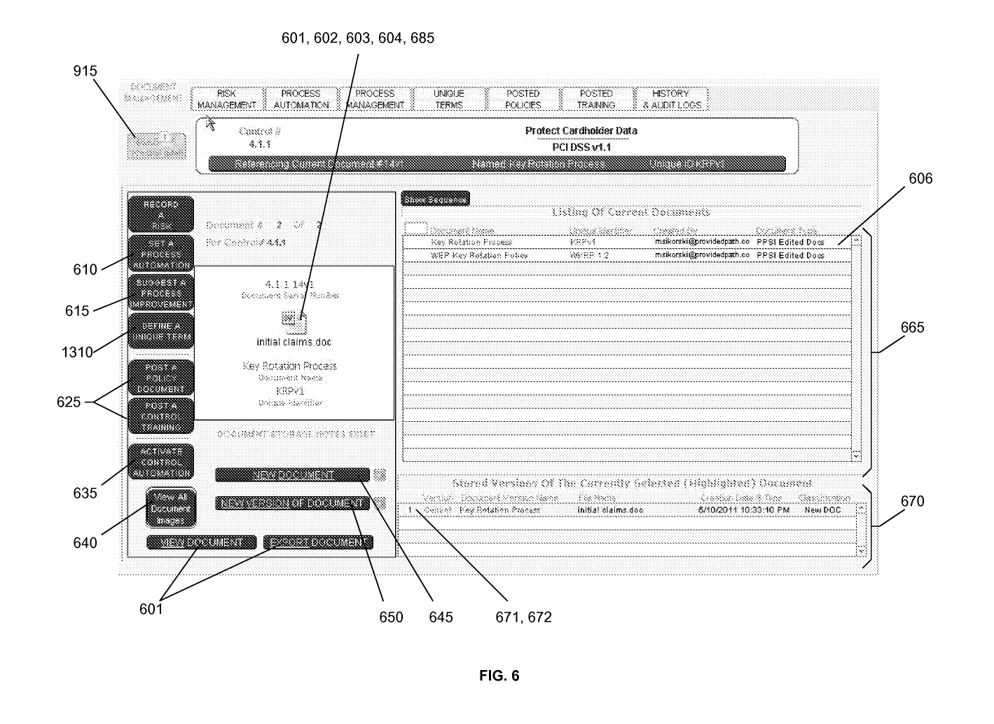

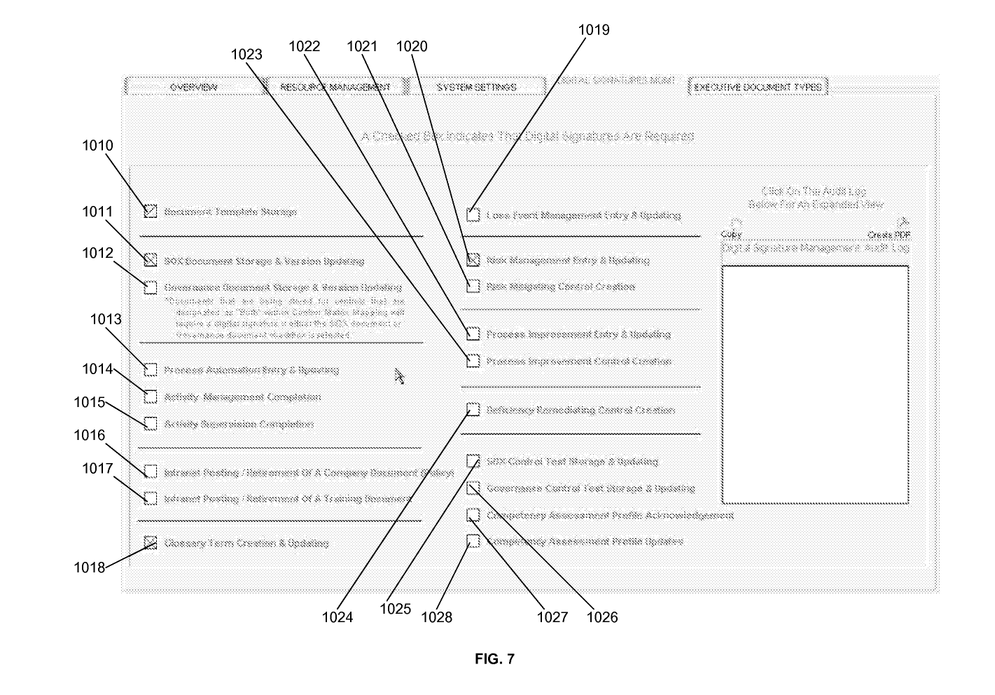

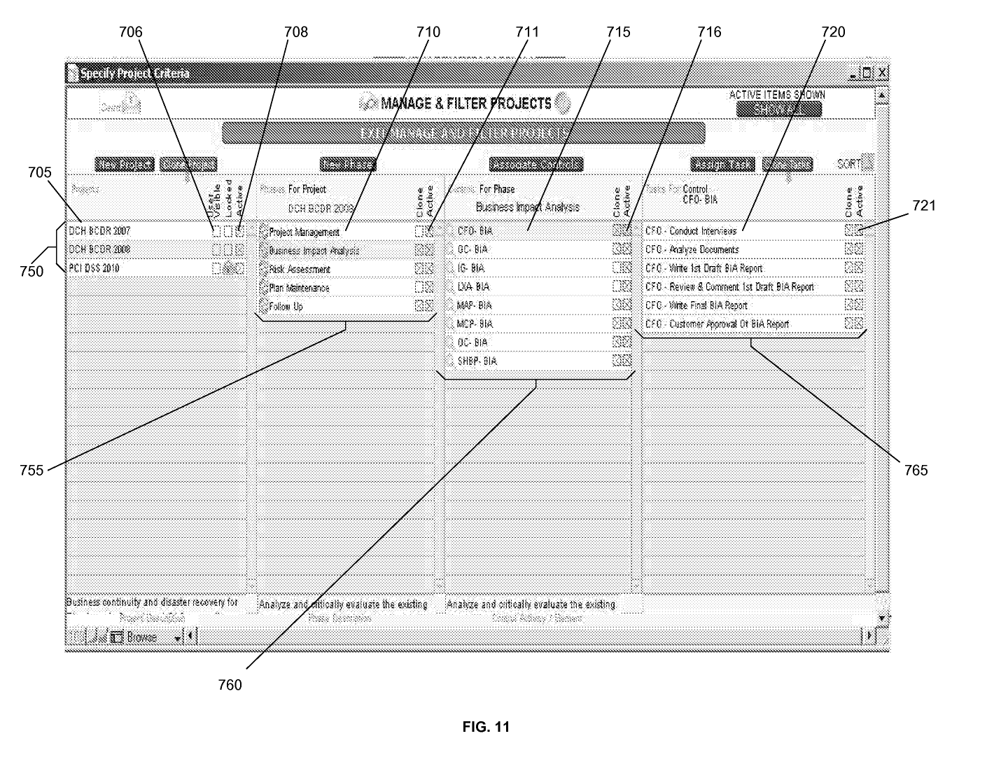

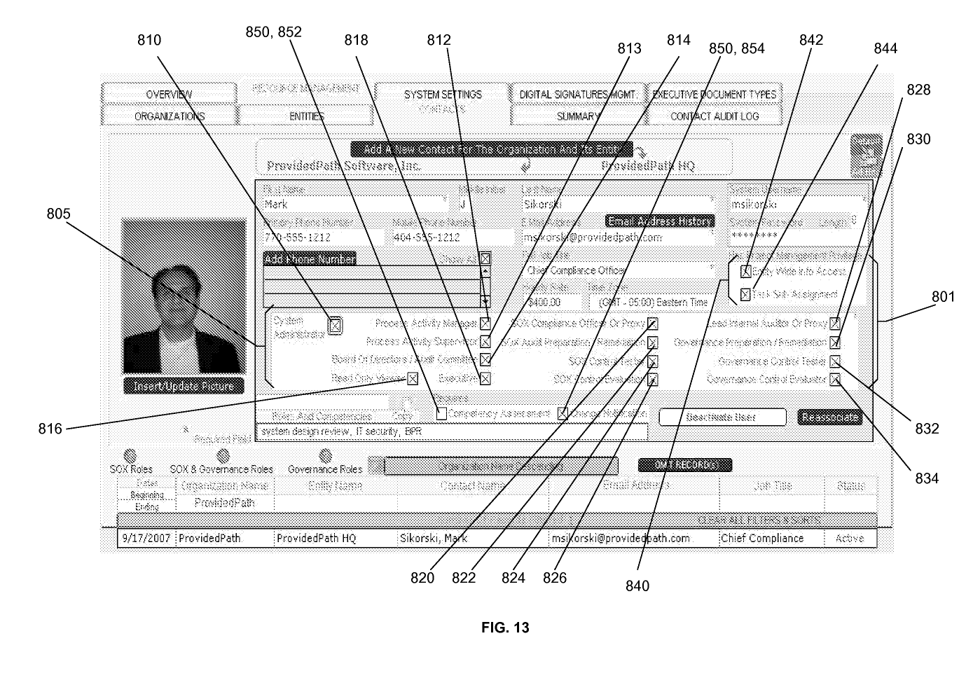

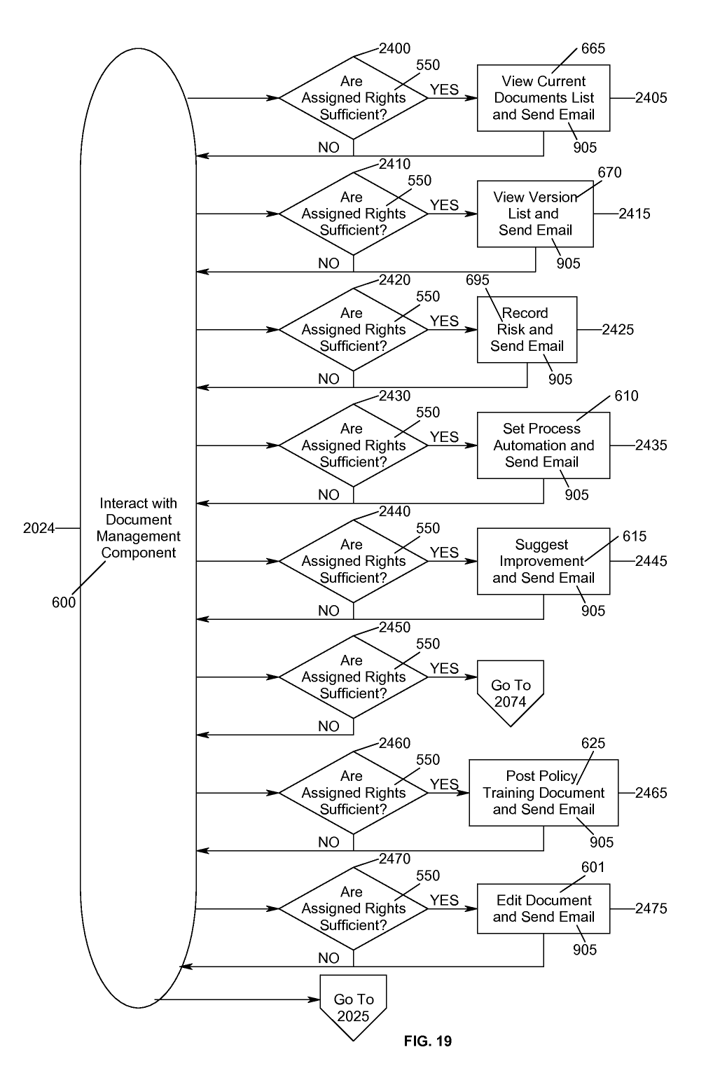

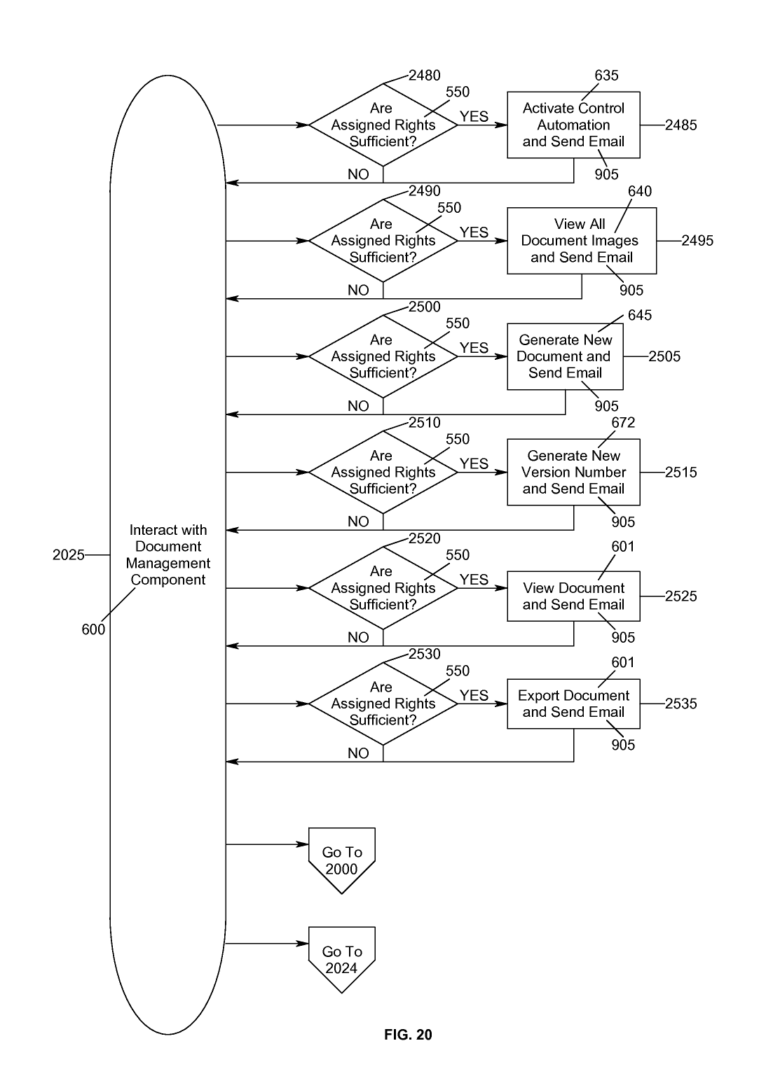

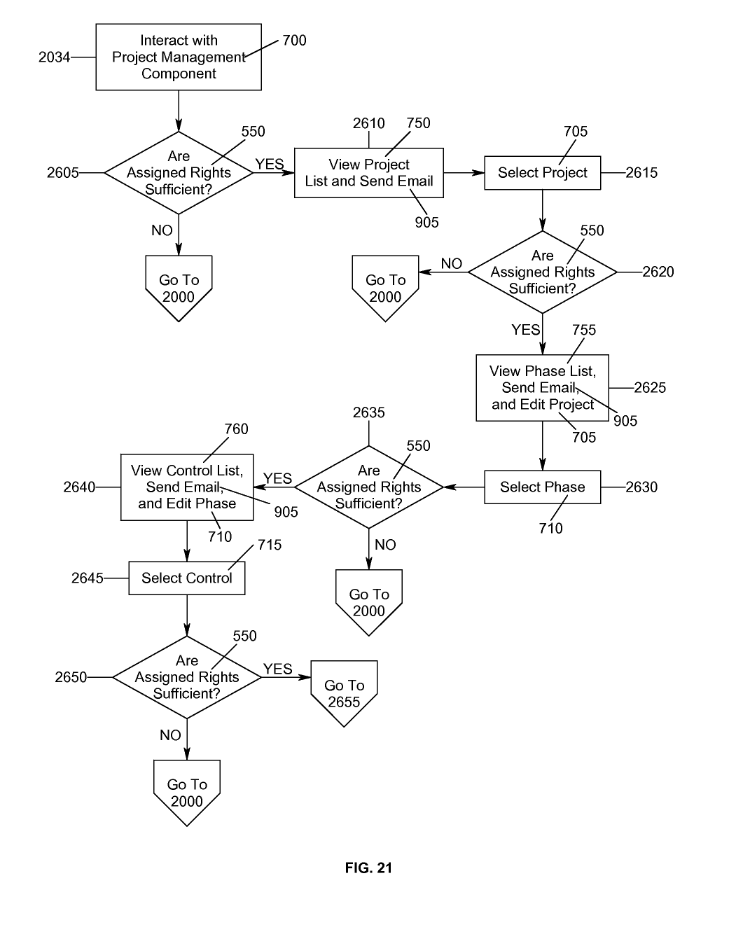

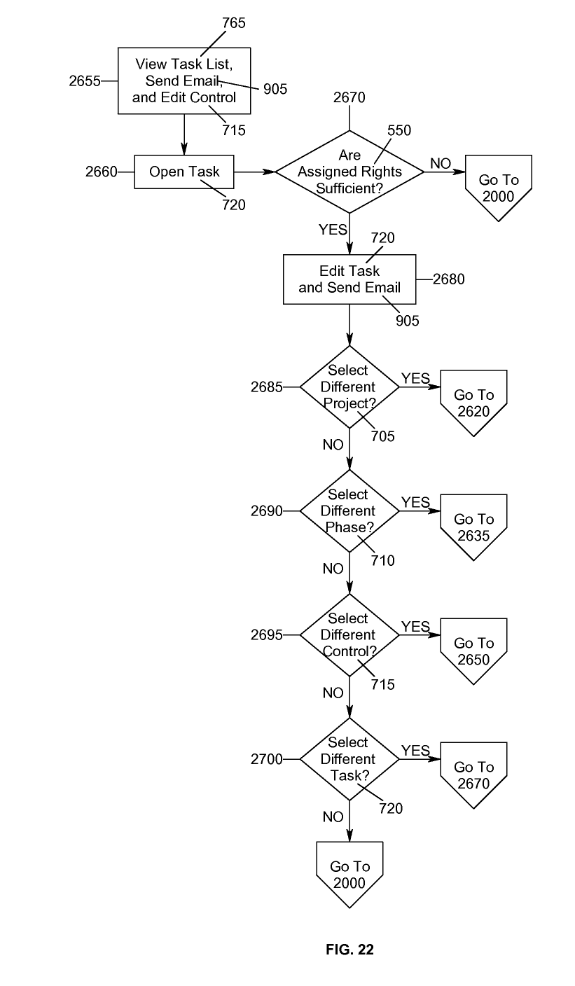

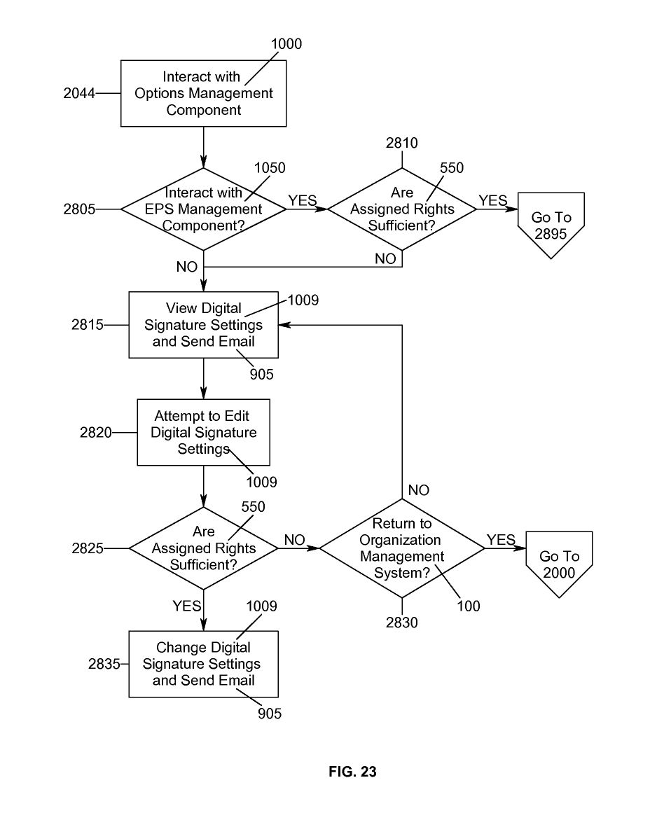

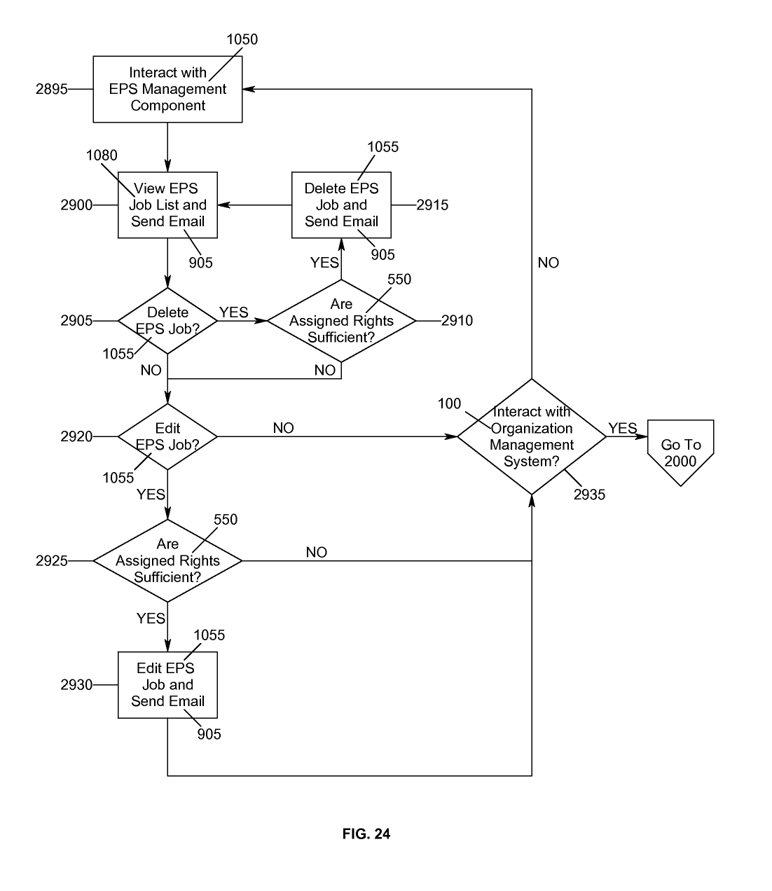

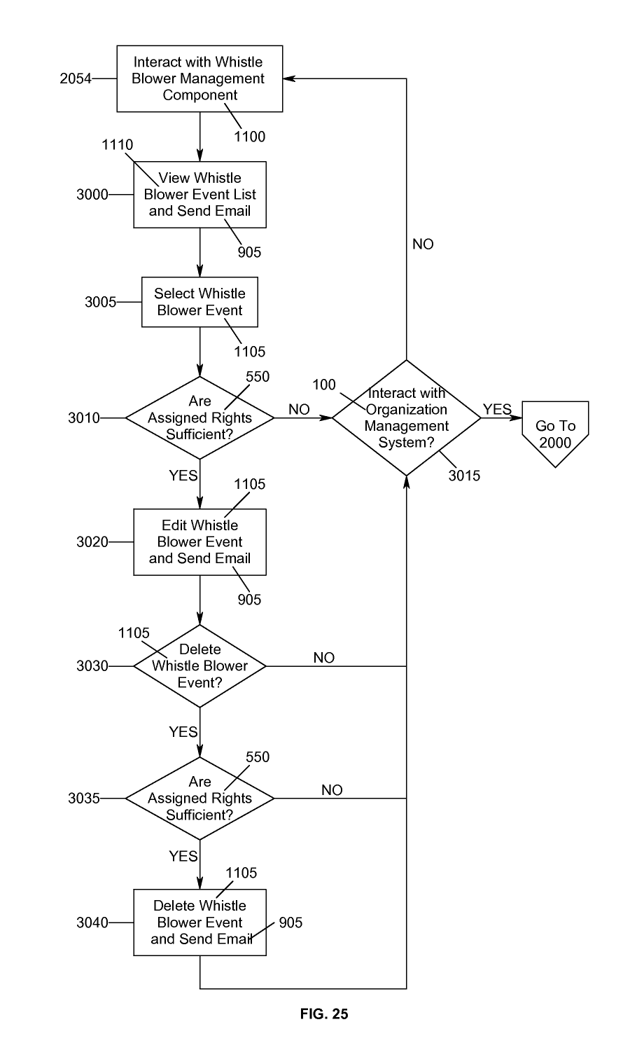

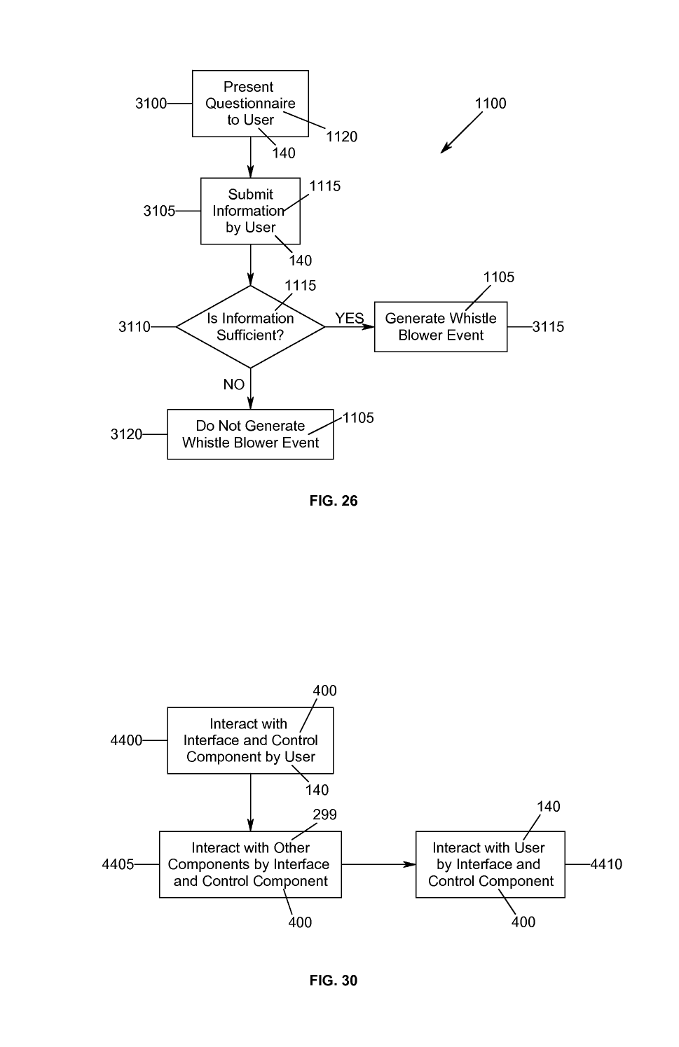

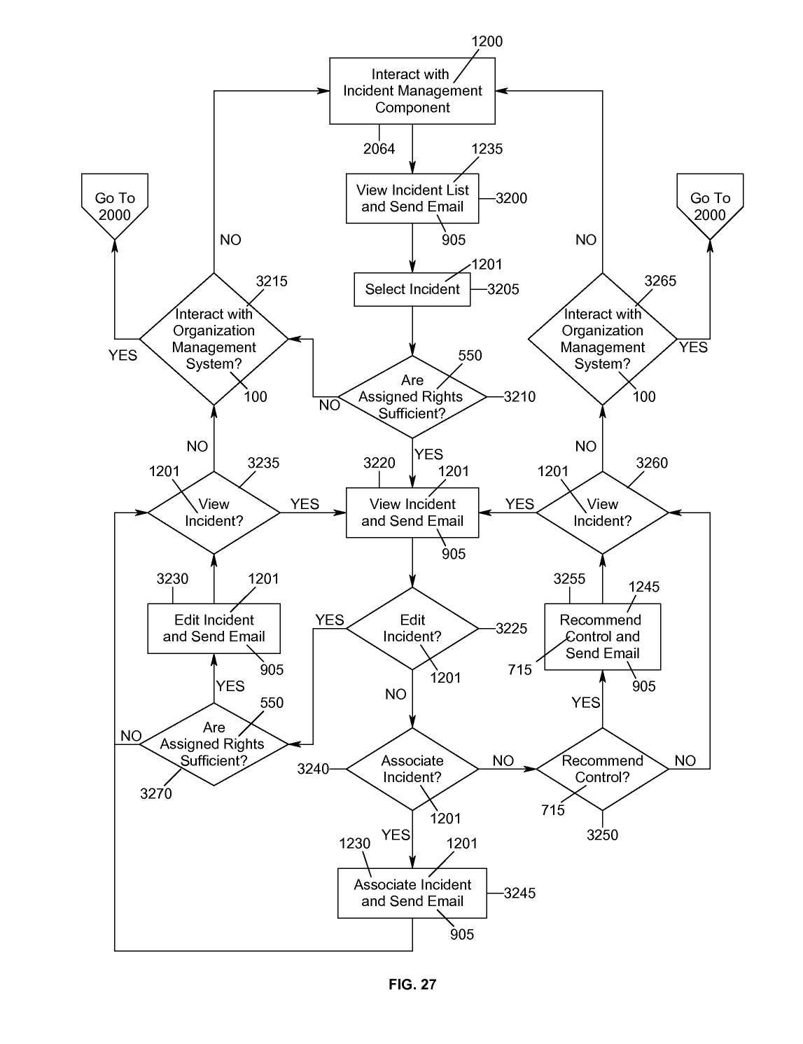

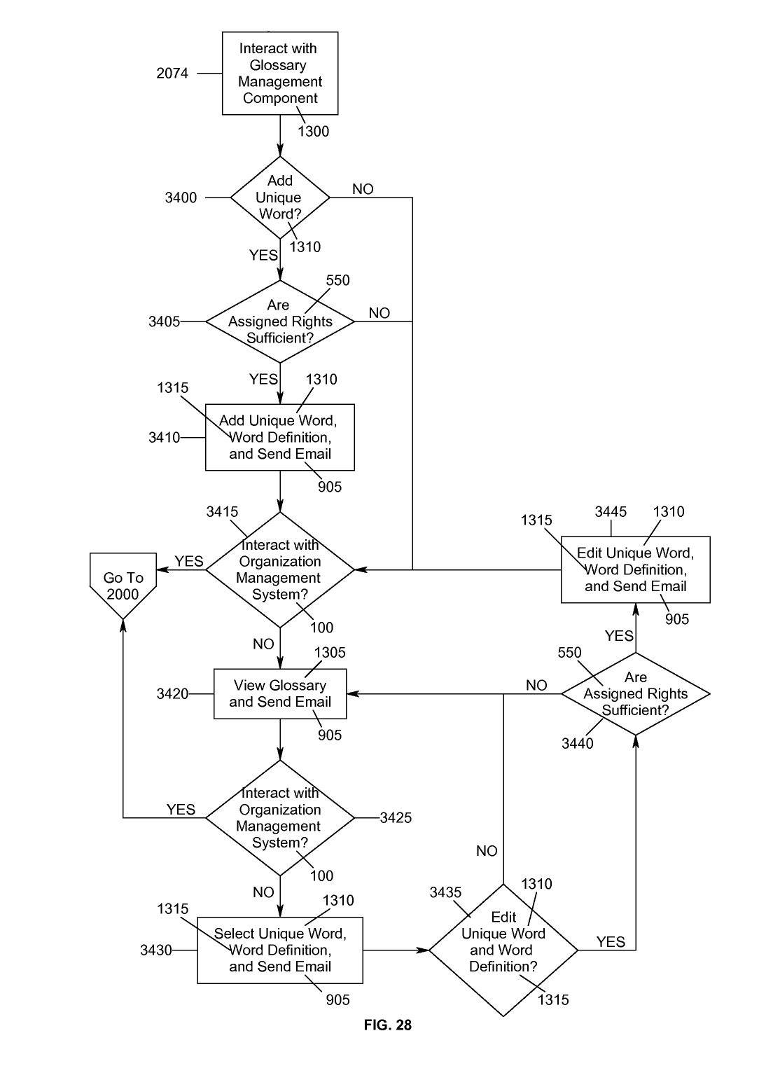

In describing the preferred and selected alternate embodiments of the present invention, as illustrated in FIGS. 1-31, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment is organization optimization system 100 having server 105 with data 180 therein (best shown in FIG. 1). Organization optimization system 100 further comprises login component 300, interface and control component 400, user management component 500, document management component 600, project management component 700, role management component 800, email management component 900, options management component 1000, whistle blower management component 1100, incident management component 1200 and glossary management component 1300. Interface and control component 400 is in communication with login component 300, user management component 500, document management component 600, project management component 700, role management component 800, email management component 900, options management component 1000, whistle blower management component 1100, incident management component 1200 and glossary management component 1300 (best shown in FIG. 3). Turning to FIGS. 3 and 30, organization optimization system 100 further comprises other components 299, wherein other components 299 comprise login component 300, interface and control component 400, user management component 500, document management component 600, project management component 700, role management component 800, email management component 900, options management component 1000, whistle blower management component 1100, incident management component 1200 and glossary management component 1300.

In a preferred embodiment, login component 300, interface and control component 400, user management component 500, document management component 600, project management component 700, role management component 800, email management component 900, options management component 1000, whistle blower management component 1100, incident management component 1200 and glossary management component 1300 are located on server 105. In an alternate embodiment, organization optimization system 100 may be located on a plurality of servers 105. Such an alternate embodiment would mitigate any technical problems that may affect organization optimization system 100, including an overburdened central processing unit (CPU), an overburdened network card, or insufficient hard drive space.

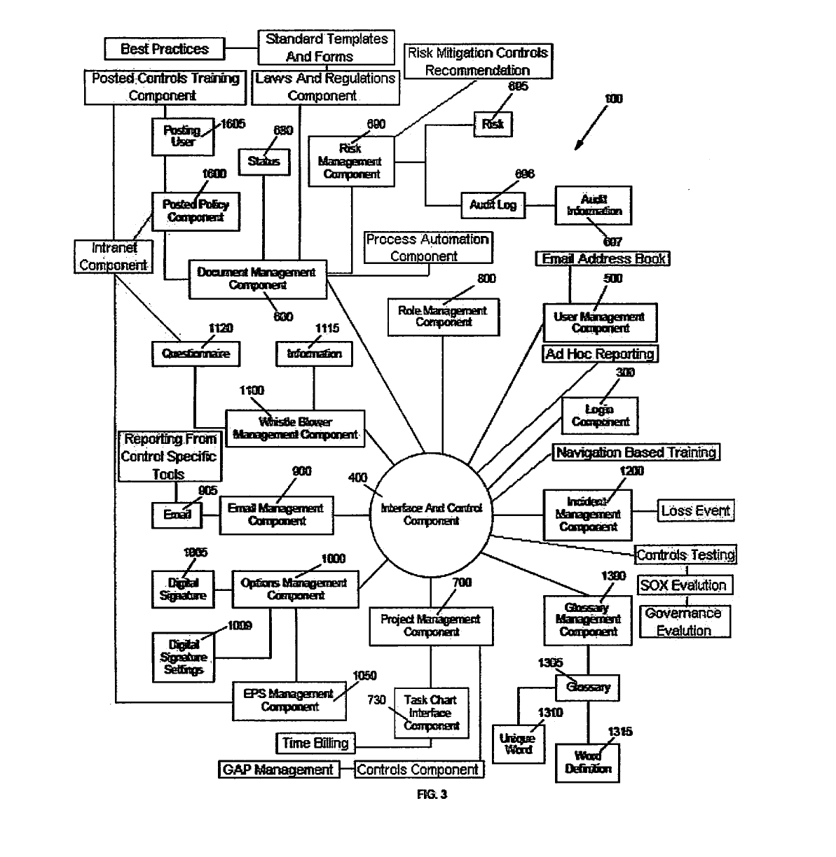

Access terminal 110 is communicatively connected to internal network 120 via user communication 150, wherein internal network 120 is communicatively connected to server 105 via user communication 150 (best shown in FIG. 1). Alternatively, access terminal 110 is communicatively connected to internet 130 via user communication 150, wherein internet 130 is communicatively connected to internal network 120 via user communication 150, wherein internal network 120 is communicatively connected to server 105 via user communication 150 (best shown in FIG. 2). In a further embodiment, internal network 120 may comprise a Virtual Private Network (VPN) or any other networking structure known and used. User 140 and second user 145 utilize access terminal 110 to communicate with organization optimization system 100 (best shown in FIGS. 1 and 2). In a preferred embodiment access terminal 110 and server 105 are computers, wherein computers are desktop, laptops, tablets, smart phones, or any functionally equivalent device as known in the arts.

Server 105 further comprises data 180, wherein data 180 is any and all information within organization optimization system 100. Turning to FIG. 2, computer system 1071 is an additional computer communicatively connected to server 105. Alternatively, computer system 1071 is the same computer as server 105. Turning to FIG. 1, access terminal 110 comprises document editor 675, wherein document editor 675 is software utilized by user 140. Access terminal 110 further comprises iconic representation 685.

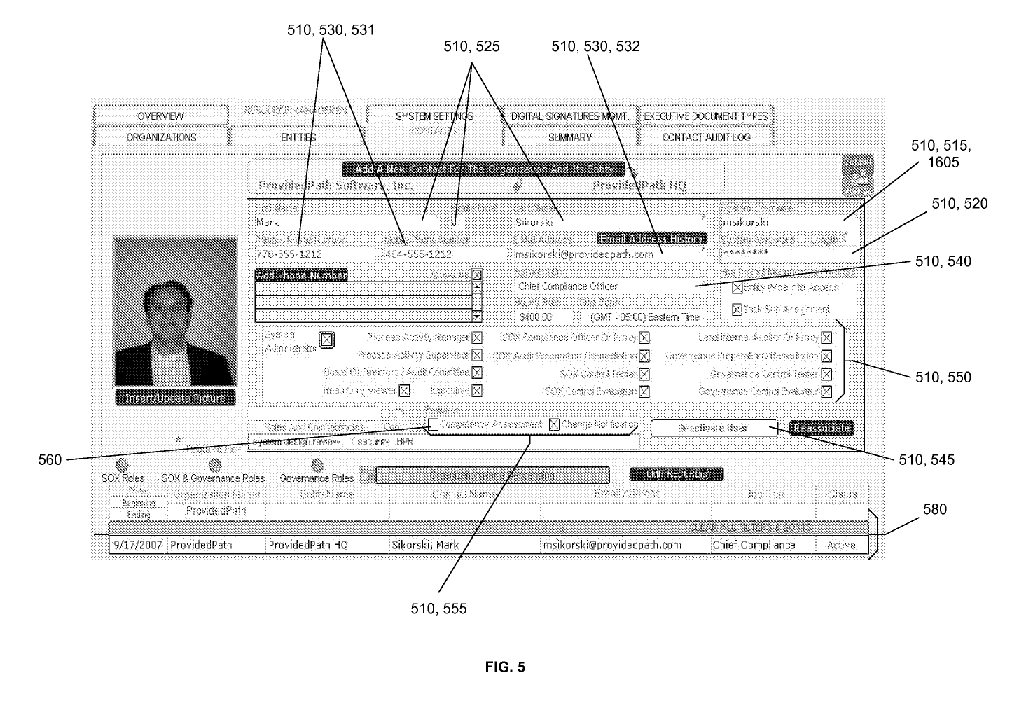

Turning now more particularly to FIGS. 3 and 5, user management component 500 comprises user account 510 and user list 580. User account 510 comprises username 515, user password 520, personal name 525, user title 540, assigned rights 550, assigned requirements 555, competency assessment 560, user status 545 and user contact information 530, wherein user contact information 530 comprises user phone number 531 and user email address 532, and wherein each username 515 is unique within user management component 500, and wherein user status 545 comprises “Active” and “Disabled”. In a preferred embodiment, user management component 500 comprises a plurality of user accounts 510, and user list 580 comprises a plurality of user accounts 510.

Turning now to FIGS. 3, 6, 16 and 31, document management component 600 comprises document 601, document template 602, SOX document 603, governance document 604, process automation 610, improvement 615, policy training document 625, control automation 635, all document images 640, new document 645, new document version 650, current documents list 665, version list 670, version number 671, new version number 672, risk management component 690, and posted policy component 1600, wherein posted policy component 1600 comprises posting user 1605. Document 601, document template 602, SOX template 603, governance template 604 and policy training document 625 comprise document type 606, wherein document type 606 comprises any type of file that can be stored on a computer, including, for exemplary purposes only, a MICROSOFT Word document, a spreadsheet, including MICROSOFT Excel, a file that has been “zipped”, or a movie. Iconic representation 685 is associated with document type 606. Document 601, document template 602, SOX document 603, governance document 604 and policy training document 625 each comprise status 680, wherein status 680 comprises “Active” and “Retired”. Risk management component 690 comprises risk 695, audit log 696 and audit information 697. Risk 695 comprises at least one risk that may have adverse effects. In a preferred embodiment, risk 695 is defined by Committee of Sponsoring Organizations of the Treadway Commission (COSO) and/or Control Objectives for Information and Related Technology (COBIT). Turning now to FIGS. 3, 5, 6 and 11, audit log 696 is associated with document 601, project 705, phase 710, control 715 or task 720, and audit log 696 identifies user account 510 that has edited document 601, project 705, phase 710, control 715 or task 720.

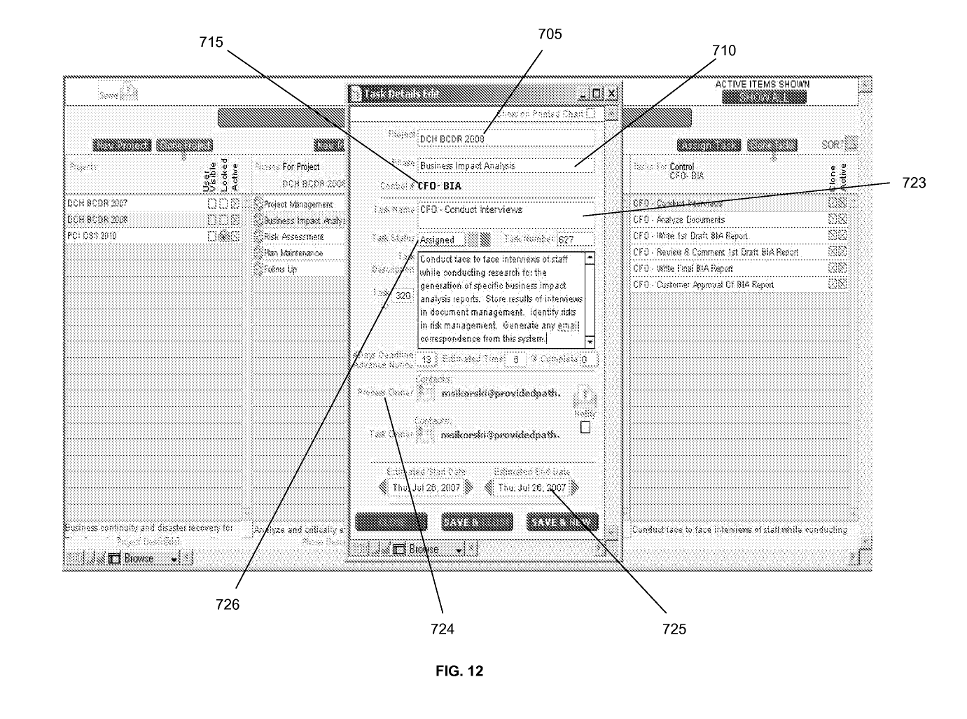

Turning now to FIGS. 3, 11 and 12, project management component 700 comprises project 705, project list 750, phase list 755, control list 760 and task list 765. Project 705 comprises project user visible 706, project active 708 and phase 710, wherein phase 710 comprises phase active 711 and control 715. Control 715 comprises control active 716 and task 720, wherein task 720 comprises task active 721, task name 723, task owner 724, task due date 725 and task status 726 (best shown in FIG. 12). Project user visible 706, project active 708, phase active 711, control active 716 and task active 721 each comprise “True” and “False”. Task due date 725 comprises a calendar date, and task status 726 comprises “Assigned”, “Begun”, “Waiting”, “Stalled” and “Performed”. Turning to FIGS. 12 and 5, task owner 724 identifies user account 510.

Turning now to FIGS. 3, 5 and 13, role management component 800 comprises rights 801 and requirements 850, wherein rights 801 comprise roles 805 and privileges 840, and wherein assigned rights 550 of user account 510 is associated with roles 805 and/or requirements 850. Roles 805 comprise system administrator role 810, process activity manager role 812, process activity supervisor role 813, audit committee role 814, read only role 816, executive role 818, SOX compliance role 820, SOX audit role 822, SOX tester role 824, SOX evaluator role 826, lead auditor role 828, governance preparation role 830, governance tester role 832 and governance evaluator role 834. Privileges 840 comprise entity wide privileges 842 and sub assignment privileges 844. Requirements 850 comprise competency requirement 852 and notification requirement 854.

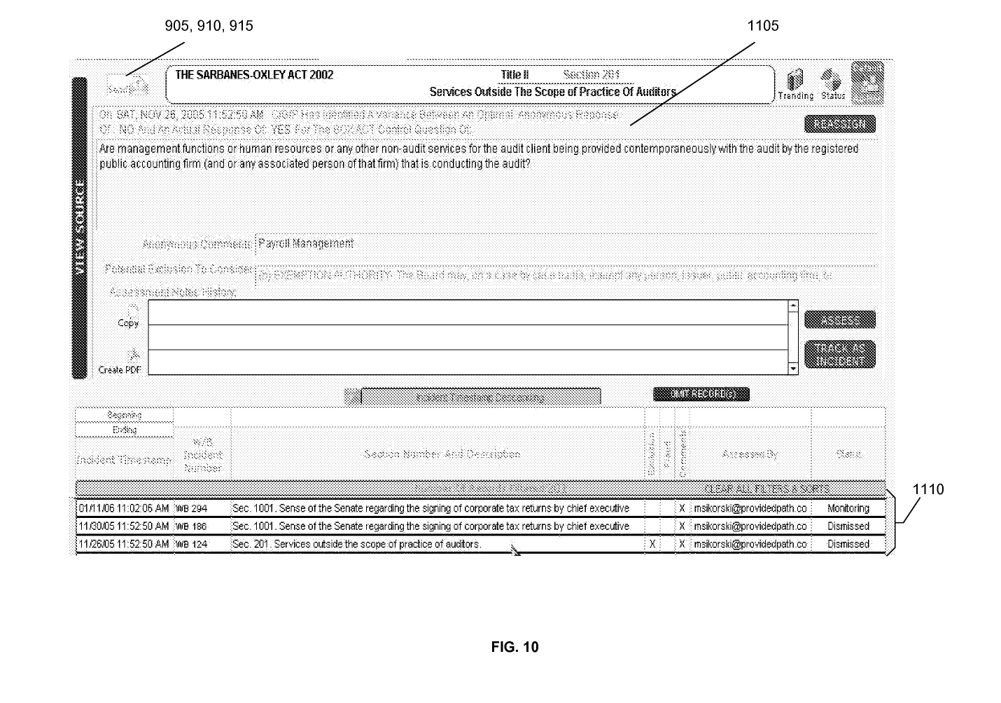

Turning now more particularly to FIGS. 3 and 10, email management component 900 comprises email 905, unique key 910 and send keyed email 915.

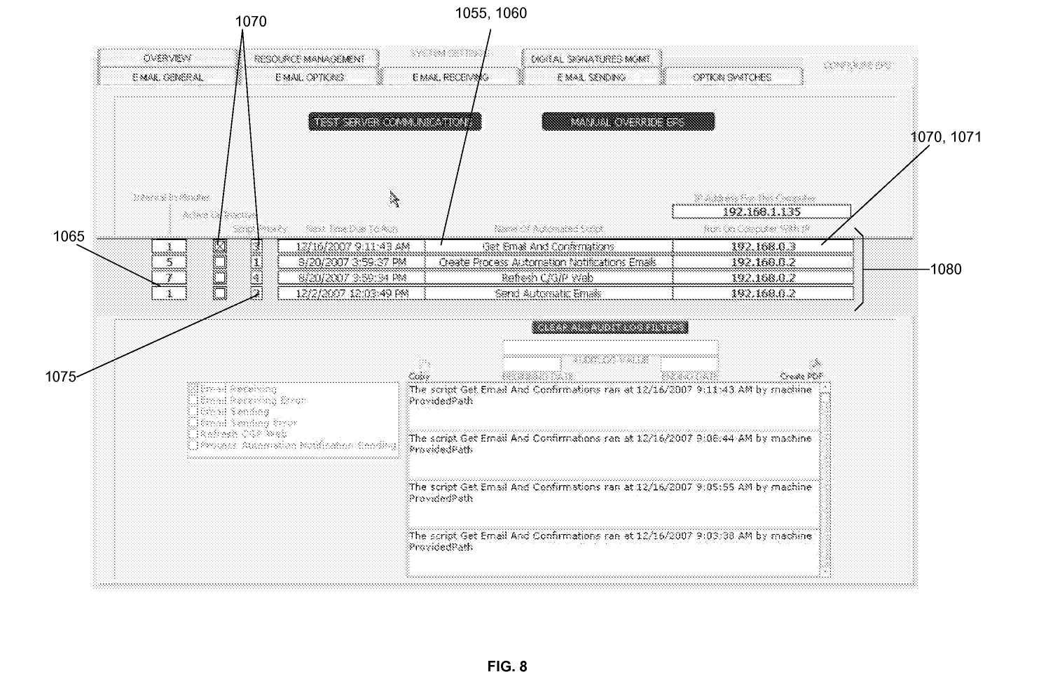

Turning now to FIGS. 3, 7, 8 and 23 options management component 1000 comprises digital signature 1005, digital signature settings 1009 and EPS management component 1050, wherein digital signature settings 1009 comprises digital signature template storage 1010, digital signature SOX document storage 1011, digital signature governance document storage 1012, digital signature process automation 1013, digital signature activity management 1014, digital signature activity supervision 1015, digital signature edit company document 1016, digital signature edit training document 1017, digital signature glossary term 1018, digital signature loss event management 1019, digital signature risk management 1020, digital signature risk mitigation 1021, digital signature process entry update 1022, digital signature process creation 1023, digital signature deficiency creation 1024, digital signature SOX control 1025, digital signature governance control 1026, digital signature competency acknowledgement 1027, and digital signature competency updates 1028, each of which comprise “Active” and “Disabled”. Digital signature 1005 identifies user account 510. Turning more particularly to FIGS. 3 and 8, EPS management component 1050 comprises EPS job 1055 and EPS job list 1080, wherein EPS job 1055 comprises EPS job name 1060, EPS job schedule 1065, EPS execution configuration 1070 and EPS job priority 1075.

Turning to FIGS. 1, 3, 5, 6, 8, 10 and 11, EPS job 1055 comprises a computer software script or program, wherein EPS job 1055 is configured to, for exemplary purposes only, update data 180, generate document 601, generate email 905, generate project 705, generate phase 710, generate control 715, generate task 720, or interact with user management component 500. EPS job schedule 1065 describes how often EPS job 1055 is executed. EPS execution configuration 1070 describes what user 140 that EPS job 1055 will run as, and EPS execution configuration 1070 further describes which computer system 1071 that EPS job 1055 will run on. EPS job priority 1075 describes the priority level of EPS job 1055 when it runs on computer system 1071.

Turning now to FIGS. 3 and 10, whistle blower management component 1100 comprises whistle blower event 1105, whistle blower event list 1110, information 1115 and questionnaire 1120.

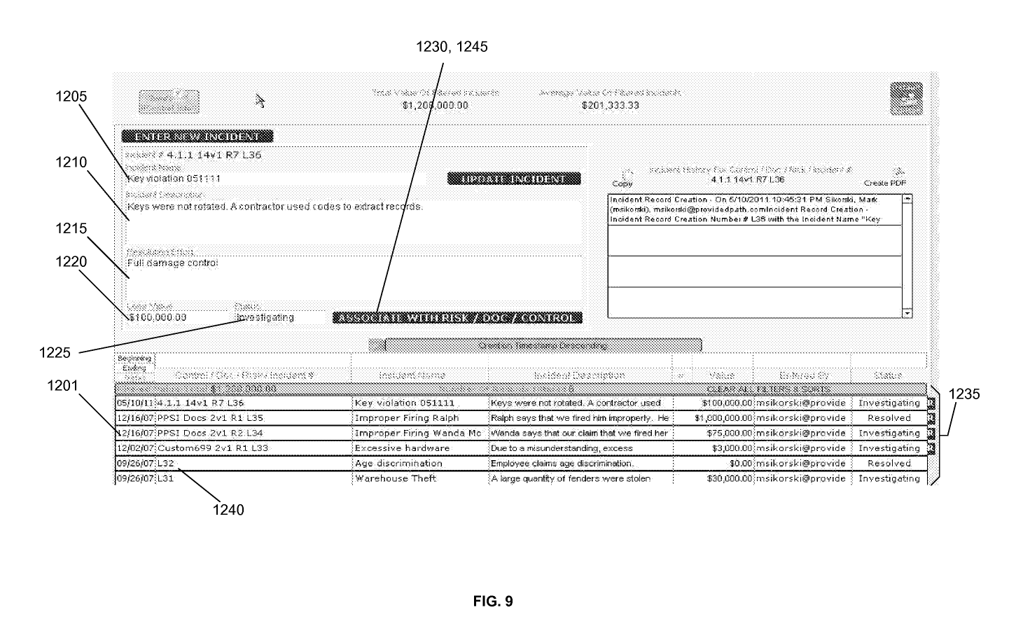

Turning now to FIGS. 3 and 9, incident management component 1200 comprises incident 1201, incident association 1230, incident list 1235, risk 1240 and control recommendation 1245, wherein incident 1201 comprises incident name 1205, incident description 1210, incident resolution 1215, incident cost 1220 and incident status 1225.

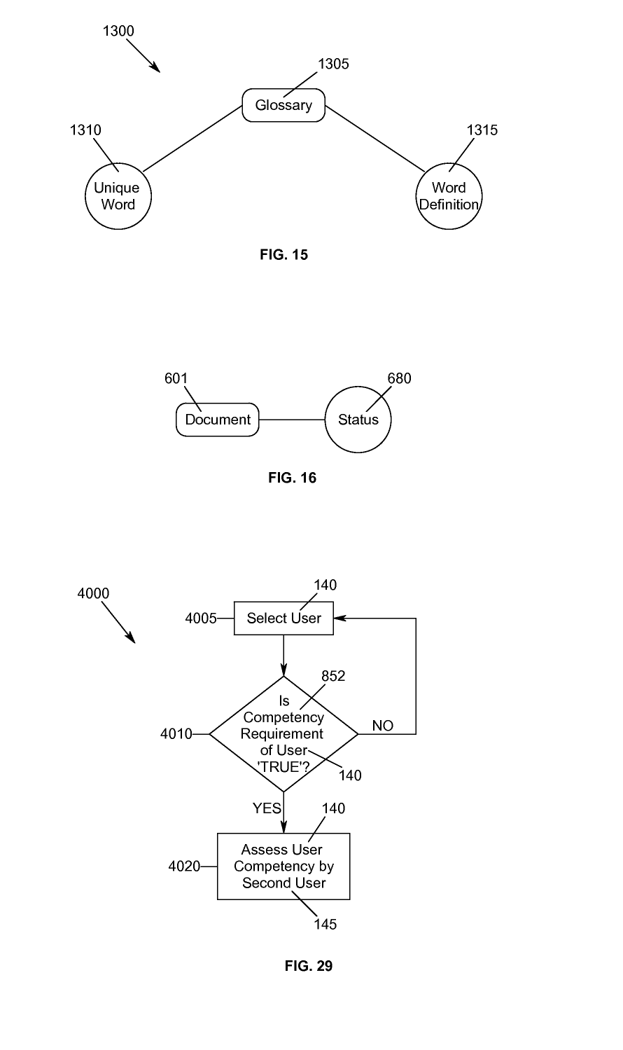

Turning now to FIGS. 3 and 15, glossary management component 1300 comprises glossary 1305, unique word 1310 and word definition 1315.

Turning now to FIGS. 3 and 14, corporation 170 comprises at least one entity 175, wherein entity 175 utilizes organization optimization system 100 (best shown in FIG. 3). It will be recognized that corporation 170 may comprises any organization, including without limitation, for profit companies, not for profit organizations, and charitable trusts.

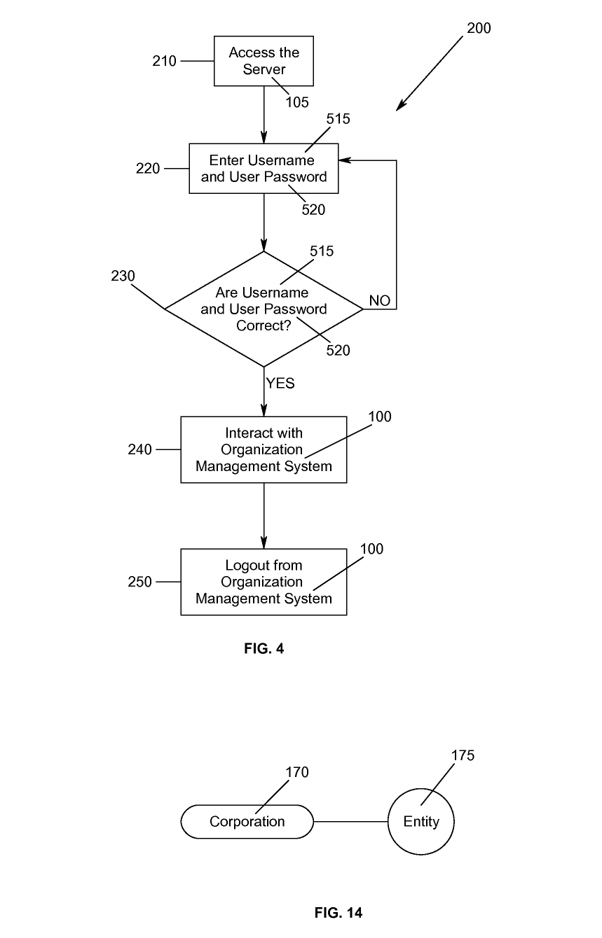

Turning more particularly to FIGS. 1, 4 and 5, user 140 begins session 200 via step 210 wherein user 140 accesses server 105. User 140 subsequently enters username 515 and user password 520 via step 220, wherein username 515 and user password 520 are associated with user account 510, and user account 510 is associated with user 140 (best shown in FIG. 5). At step 230 it is determined, (1) if username 515 and user password 520 are correct, and (2) if user account 510 comprises user status 545, wherein user status 545 comprises “Active” (best shown in FIG. 5). If username 515 and user password 520 is incorrect, or if user account 510 comprises user status 545, wherein user status 545 comprises “Disabled”, session 200 returns to step 220, wherein user 140 may again enter username 515 and user password 520. If username 515 and user password 520 are correct, and user account 510 comprises user status 545, wherein user status 545 comprises “Active”, session proceeds to step 240, wherein user 140 interacts with organization optimization system 100, wherein interacting comprises viewing, editing and/or creating data 180 within organization optimization system 100, including, for exemplary purposes only, viewing and/or editing user account 510, document 601, risk 695, audit log 696, project 705, phase 710, control 715, task 720, email 905, unique key 910, EPS job 1055, whistle blower event 1105, incident 1201, risk 1240, unique word 1310 and/or word definition 1315 (FIGS. 1, 3, 5, 6, 7, 8, 9 and 10). Turning back to FIGS. 1 and 4, when user 140 finishes interacting with organization optimization system 100, session 200 proceeds to step 250, wherein user 140 is disconnected from organization optimization system 100. It will be recognized that user authentication can be performed by any mechanism known in the art, including without limitation, LDAP.

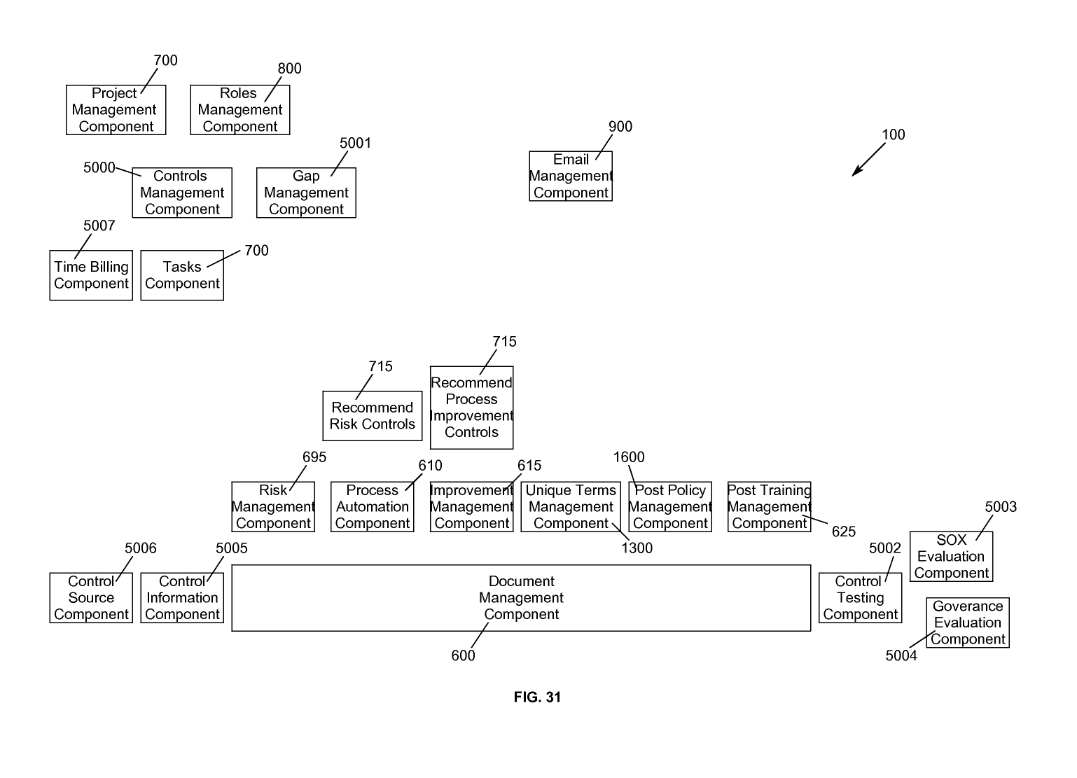

Turning to FIG. 31, in a preferred embodiment, organization optimization system 100 further comprises controls management component 5000, gap management component 5001, time billing component 5007, control source component 5006, control information component 5005, control testing component 5002, SOX evaluation component 5003 and governance evaluation component 5004.

Turning to FIGS. 1, 3 and 30, in a preferred embodiment, while user 140 is in session 200, user 140 communicates with interface and control component 400 via step 4400. At step 4405 interface and control component 400 communicates with login component 300, user management component 500, document management component 600, project management component 700, role management component 800, email management component 900, options management component 1000, whistle blower management component 1100, incident management component 1200 and glossary management component 1300 via step 4405 (best shown in FIG. 3), and, subsequently, interface and control component 400 resumes communicating with user 140 via step 4410.

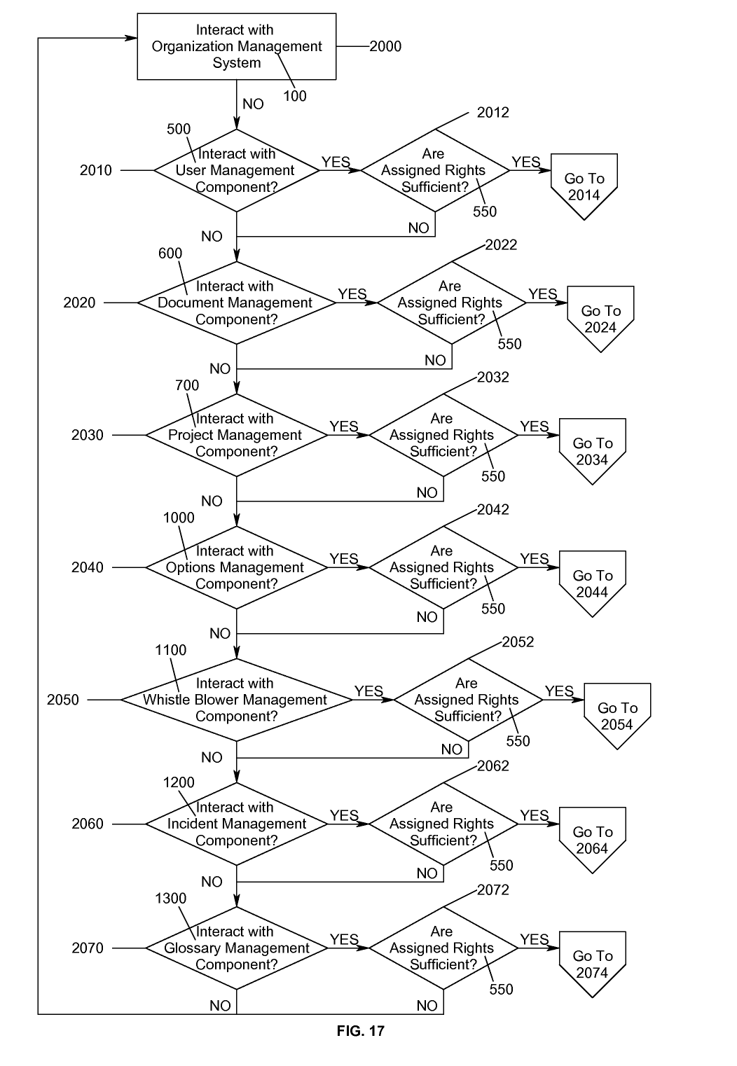

Turning now more particularly to FIGS. 1 and 17, user 140 interacts with organization optimization system 100 via step 2000. User 140 proceeds to step 2010, and at step 2010, if user 140 chooses to interact with user management component 500, then user 140 proceeds to step 2012; otherwise, user 140 proceeds to step 2020. If, at step 2012, user 140 has sufficient access rights 550, then user 140 proceeds to step 2014; otherwise, user 140 proceeds to step 2020. If, at step 2020, user 140 chooses to interact with document management component 600, then user 140 proceeds to step 2022; otherwise, user 140 proceeds to step 2030. If, at step 2022, user 140 has sufficient access rights 550 then user 140 proceeds to step 2024; otherwise, user 140 proceeds to step 2030. If, at step 2030, user 140 chooses to interact with project management component 700, then user 140 proceeds to step 2032; otherwise, user 140 proceeds to step 2040. If, at step 2032, user 140 has sufficient access rights 550 then user 140 proceeds to step 2034; otherwise, user 140 proceeds to step 2040. If, at step 2040, user 140 chooses to interact with options management component 1000, then user 140 proceeds to step 2042; otherwise, user 140 proceeds to step 2050. If, at step 2042, user 140 has sufficient access rights 550, then user 140 proceeds to step 2044; otherwise, user 140 proceeds to step 2050. If, at step 2050, user 140 chooses to interact with whistle blower management component 1100, then user 140 proceeds to step 2052; otherwise, user 140 proceeds to step 2060. If, at step 2052, user 140 has sufficient access rights 550, then user 140 proceeds to step 2054; otherwise, user 140 proceeds to step 2060. If, at step 2060, user 140 chooses to interact with incident management component 1200, then user 140 proceeds to step 2062; otherwise, user 140 proceeds to step 2070. If, at step 2062, user 140 has sufficient access rights 550, then user 140 proceeds to step 2064; otherwise, user 140 proceeds to step 2070. If, at step 2070, user 140 chooses to interact with glossary management component 1300, then user 140 proceeds to step 2072; otherwise, user 140 returns to step 2000. If, at step 2072, user 140 has sufficient access rights 550, then user 140 proceeds to step 2074; otherwise, user 140 returns to step 2000.

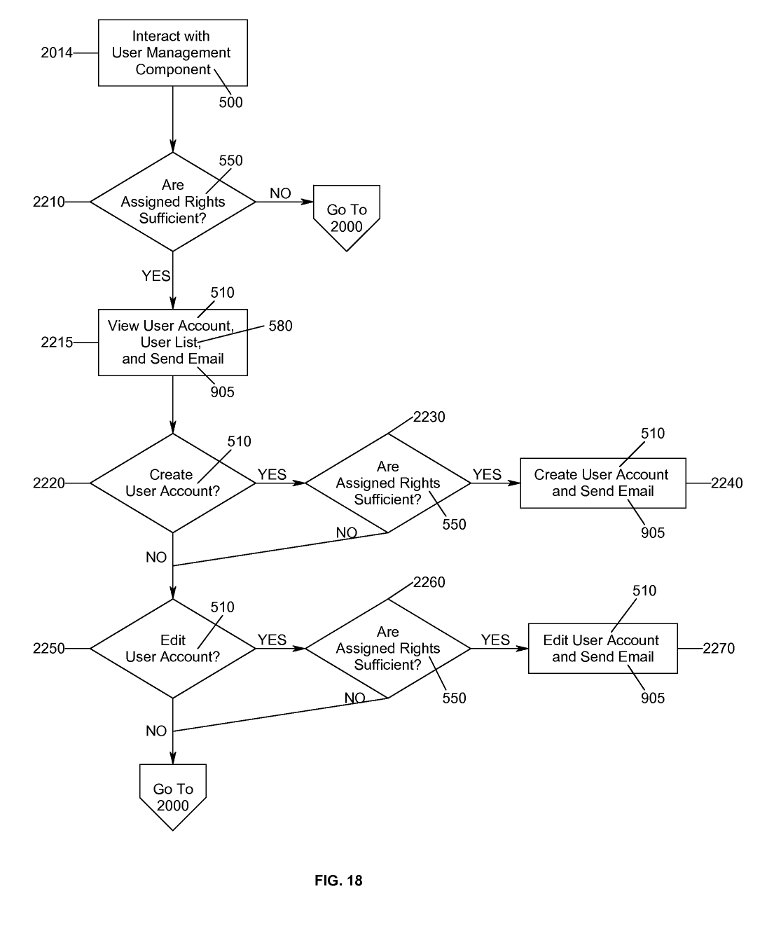

Turning now to FIGS. 1 and 18, user 140 interacts with user management component 500 via step 2014. At step 2210, if user 140 has insufficient assigned rights 550, then user 140 interacts with organization optimization system 100 at step 2000; otherwise, user 140 views user account 510 and user list 580 and user 140 selectively sends email 905 via step 2215. From step 2215 user 140 proceeds to step 2220, and at step 2220, if user 140 wants to create user account 510, then user 140 proceeds to step 2230; otherwise, user 140 proceeds to step 2250. At step 2230, if user 140 has insufficient assigned rights 550, then user 140 proceeds to step 2250; otherwise, user 140 creates user account 510 and selectively sends email 905 via step 2240. At step 2250, if user 140 wants to edit user account 510, then user 140 proceeds to step 2260; otherwise, user 140 proceeds to step 2000. At step 2260, if user 140 has insufficient assigned rights 550, then user 140 proceeds to step 2000; otherwise, user 140 edits user account 510 and selectively sends email 905 via step 2270.

Turning to FIGS. 1, 3, 6 and 19, while interacting with document management component 600 via step 2024, user 140 can selectively elect to proceed to step 2400, and, if user 140 has sufficient assigned rights 550, then user 140 proceeds to step 2405, wherein user 140 selectively sends email 905 and user 140 views current document list 665, and wherein current document list 665 comprises at least one document 601. If, at step 2400, user 140 does not have sufficient assigned rights 550, then user 140 returns to step 2024.

Via step 2024, user 140 can also selectively elect to proceed to step 2410, and if user 140 has sufficient assigned rights 550 then user 140 proceeds to step 2415, wherein user 140 selectively sends email 905 and user 140 views version list 670, and wherein version list 670 comprises at least one version number 671 and/or at least one new version number 672 associated with document 601. If, at step 2410, user 140 does not have sufficient assigned rights 550, then user 140 returns to step 2024.

Turning to FIGS. 1, 3, 6, 7 and 19, via step 2024, user 140 can also selectively elect to proceed to step 2420, and if user 140 has sufficient assigned rights 550 then user 140 proceeds to step 2425, wherein user 140 selectively sends email 905 and user 140 can record risk 695, and wherein recording risk 695 comprises associating risk 695 with document 601 or control 715. If, at step 2420, user 140 does not have sufficient assigned rights 550, then user 140 returns to step 2024.

Via step 2024, user 140 can also selectively elect to proceed to step 2430, and if user 140 has sufficient assigned rights 550 then user 140 proceeds to step 2435, wherein user 140 selectively sends email 905 and user 140 can set process automation 610, and wherein process automation 610 comprises user 140 associating document 601 with task 720. For exemplary purposes only, if a company is required to pay insurance premiums, the process or procedure for paying insurance premiums is defined within document 601. If, at step 2430, user 140 does not have sufficient assigned rights 550, then user 140 returns to step 2024.

Via step 2024, user 140 can also selectively elect to proceed to step 2440, and if user 140 has sufficient assigned rights 550, then user 140 proceeds to step 2445, wherein user 140 selectively sends email 905 and user 140 can suggest improvement 615, and wherein suggesting improvement 615 comprises user 140 associating improvement 615 with document 601. For exemplary purposes only, improvement 615 may be related to the creation of new task 720, control 715, phase 710 or project 705. If, at step 2440, user 140 does not have sufficient assigned rights 550, then user 140 returns to step 2024.

Via step 2024, user 140 can also selectively elect to proceed to step 2450, and if user 140 has sufficient assigned rights 550, then user 140 proceeds to step 2074; otherwise, user 140 returns to step 2024.

Via step 2024, user 140 can also selectively elect to proceed to step 2460, and if user 140 has sufficient assigned rights 550, then user 140 proceeds to step 2465 wherein user 140 selectively sends email 905 and user 140 can post policy training document 625, and wherein posting policy training document 625 comprises user 140 saving policy training document 625 in document management component 600, and wherein policy training document 625 relates to control 715 or to training user 140 or second user 145. If, at step 2460, user 140 does not have sufficient assigned rights 550, then user 140 returns to step 2024.

Via step 2024, user 140 can also selectively elect to proceed to step 2470, and if user 140 has sufficient assigned rights 550, then user 140 proceeds to step 2475, wherein user 140 selectively sends email 905 and user 140 edits document 601 with document editor 675. If, at step 2470, user 140 does not have sufficient assigned rights 550, then user 140 proceeds to step 2024. Finally, via step 2024, user 140 can also proceed to step 2025.

Turning now to FIGS. 1, 6, 7 and 20, via step 2025 user 140 can also selectively elect to proceed to step 2480, and if user 140 has sufficient assigned rights 550, then user 140 proceeds to step 2485, wherein user 140 selectively sends email 905 and user 140 can activate control automation 635, and wherein control automation 635 comprises user 140 changing status 680 of document 601, task 720, control 715, phase 710 and/or project 705 from “Disabled” to “Active”. If, at step 2480, user 140 does not have sufficient assigned rights 550, then user 140 returns to step 2025.

Via step 2025, user 140 can also selectively elect to proceed to step 2490, and if user 140 has sufficient assigned rights 550 then user 140 proceeds to step 2495, wherein user 140 selectively sends email 905 and user 140 can view all document images 640, and wherein all document images 640 comprises iconic representations 685 of document type 606 of at least one document 601. If, at step 2490, user 140 does not have sufficient assigned rights 550, then user 140 returns to step 2025.

Via step 2025 user 140 can selectively elect to proceed to step 2500, and if user 140 has sufficient assigned rights 550, then user 140 proceeds to step 2505, wherein user 140 selectively sends email 905 and user 140 can generate new document 645, and wherein new document 645 comprises user 140 creating and saving new document 645 in document management component 600. If, at step 2500, user 140 does not have sufficient assigned rights 550, then user 140 returns to step 2025.

Via step 2025, user 140 can also selectively elect to proceed to step 2510, and if user 140 has sufficient assigned rights 550 then user 140 proceeds to step 2515, wherein user 140 selectively sends email 905 and user 140 can generate new document version 650, and wherein document 601 was associated with version number 671, and wherein generating new document version 650 comprises user 140 associating document 601 with new version number 672. If, at step 2510, user 140 does not have sufficient assigned rights 550, then user 140 returns to step 2025.

Via step 2025, user 140 can also selectively elect to proceed to step 2520, and if user 140 has sufficient assigned rights 550 then user 140 proceeds to step 2525, wherein user 140 selectively sends email 905 and user 140 can view document 601, wherein viewing document 601 comprises user 140 viewing at least one document 601 with document editor 675. If, at step 2520, user 140 does not have sufficient assigned rights 550, then user 140 returns to step 2025.

Via step 2025, user 140 can also selectively elect to proceed to step 2530, and if user 140 has sufficient assigned rights 550 then user 140 proceeds to step 2535, wherein user 140 selectively sends email 905 and user 140 can export document 601, and wherein exporting document 601 comprises saving document 601 outside of document management component 600. If, at step 2400, user 140 does not have sufficient assigned rights 550, then user 140 returns to step 2025.

Via step 2025, user 140 can also selectively interact with organization optimization system 100 via step 2000. Finally, via step 2025, user 140 can selectively proceed to step 2024.

Turning now to FIGS. 1, 3 and 18-27, risk management component 690 appends audit information 697 to audit log 696 via step 2425, wherein step 2425 further comprises audit log 696 which is associated with document 601 that risk 695 is being associated with, and audit information 697 is associated with user 140 at step 2425. Risk management component 690 appends audit information 697 to audit log 696 via step 2435, wherein step 2435 further comprises audit log 696 which is associated with document 601 or task 720, and wherein audit information 697 is associated with user 140 at step 2435. Risk management component 690 appends audit information 697 to audit log 696 via step 2445, wherein step 2445 further comprises audit log 696 which is associated with document 601 that improvement 615 is being associated with, and wherein audit information 697 is associated with user 140 at step 2445. Risk management component 690 appends audit information 697 to audit log 696 via step 2465, wherein step 2465 further comprises audit log 696 which is associated with document 601 that is being posted at step 2465, and wherein audit information 697 is associated with user 140 at step 2465. Risk management component 690 appends audit information 697 to audit log 696 step 2475, wherein step 2475 further comprises audit log 696 which is associated with document 601 that is being edited at step 2475, and wherein audit information 697 is associated with user 140 at step 2475. Risk management component 690 appends audit information 697 to audit log 696 via step 2505, wherein step 2505 further comprises audit log 696 which is associated with document 601 that is being generated, and wherein audit information 697 is associated with user 140 at step 2505. Risk management component 690 appends audit information 697 to audit log 696 via step 2515, wherein step 2515 further comprises audit log 696 which is associated with document 601 for which new version number 672 is being created, and wherein audit information 697 is associated with user 140 at step 2515. Risk management component 690 appends audit information 697 to audit log 696 via step 2625, wherein step 2625 further comprises audit log 696 which is associated with project 705 that is being edited, and wherein audit information 697 is associated with user 140 at step 2625. Risk management component 690 appends audit information 697 to audit log 696 via step 2640, wherein step 2640 further comprises audit log 696 which is associated with phase 710 that is being edited, and wherein audit information 697 is associated with user 140 at step 2640. Risk management component 690 appends audit information 697 to audit log 696 via step 2655, wherein step 2655 further comprises audit log 696 which is associated with control 715 that is being edited, and wherein audit information 697 is associated with user 140 at step 2655. Risk management component 690 appends audit information 697 to audit log 696 via step 2680, wherein step 2680 further comprises audit log 696 which is associated with task 720 that is being edited, and wherein audit information 697 is associated with user 140 at step 2680.

Turning to FIGS. 1, 5, 7, and 21, in a preferred embodiment, while interacting with project management component 700 via step 2034, user 140 proceeds to step 2605. If, at step 2605, user 140 has sufficient assigned rights 550, then user 140 proceeds to step 2610; otherwise, user 140 proceeds to step 2000. Via step 2610, user 140 can selectively send email 905 and user 140 can view project list 750, wherein project list 750 comprises every project 705 in project management component 700, and wherein user 140 has assigned rights 550 sufficient to see every project 705 in project list 750, and wherein every project 705 in project list 750 comprises project user visible 706 and project active 708, and wherein project user visible 706 and project active 708 comprise “True”. User 140 proceeds to step 2615, wherein user 140 selects project 705, and subsequently user 140 proceeds to step 2620. If, at step 2620, user 140 has sufficient assigned rights 550, then user 140 proceeds to step 2625; otherwise, user 140 proceeds to step 2000.

Via step 2625, user 140 can selectively send email 905, edit project 705 and view phase list 755, wherein phase list 755 comprises every phase 710 in project 705, and wherein user 140 has sufficient assigned rights 550 to see every phase 710 in project 705, and wherein every phase 710 in project 705 comprises phase active 711, and wherein phase active 711 comprises “True”. User 140 proceeds to step 2630, wherein user 140 selects phase 710, and subsequently user 140 proceeds to step 2635. If, at step 2635, user 140 has sufficient assigned rights 550, then user 140 proceeds to step 2640; otherwise, user 140 proceeds to step 2000.

Via step 2640, user 140 can selectively send email 905, edit phase 710 and view control list 760, wherein control list 760 comprises every control 715 in phase 710, and wherein user 140 has sufficient assigned rights 550 to see every control 715 in phase 710, and wherein every control 715 in phase 710 comprises control active 716, and wherein control active 716 comprises “True”. User 140 proceeds to step 2645, wherein user 140 selects control 715, and subsequently user 140 proceeds to step 2650. If, at step 2650, user 140 has sufficient assigned rights 550, then user 140 proceeds to step 2655; otherwise, user 140 proceeds to step 2000.

Turning to FIGS. 1, 5, 7, and 22, via step 2655, user 140 can selectively send email 905, edit control 715 and view task list 765, wherein task list 765 comprises every task 720 in control 715, and wherein user 140 has sufficient assigned rights 550 to see every task 720 in phase 715, and wherein every task 720 in control 715 comprises task active 721, and wherein task active 721 comprises “True”. User 140 proceeds to step 2660 where user 140 selects task 720, and subsequently user 140 proceeds to step 2670. If, at step 2670, user 140 has sufficient assigned rights 550, then user 140 proceeds to step 2680; otherwise, user 140 proceeds to step 2000.

Via step 2680, user 140 can selectively send email 905 and user 140 can edit task active 721, task name 723, task owner 724, task due date 725 and task status 726. User then proceeds to step 2685. If, at step 2685, user 140 selects project 705, then user 140 proceeds to step 2620; otherwise, user 140 proceeds to step 2690.

If, at step 2690, user 140 selects phase 710, then user 140 proceeds to step 2635; otherwise, user 140 proceeds to step 2695. If, at step 2695, user 140 selects control 715, then user 140 proceeds to step 2650; otherwise, user 140 proceeds to step 2700. If, at step 2700, user 140 selects task 720, then user 140 proceeds to step 2670; otherwise, user 140 proceeds to step 2000.

Turning to FIGS. 1, 5, 7, 21 and 22, editing project 705 at step 2625, editing phase 710 at step 2640, editing control 715 at step 2655 and editing task 720 at step 2680 comprise both editing, deleting and/or creating project 705, phase 710, control 715 and task 720.

Turning now to FIGS. 1, 3, 5, 7 and 23, user 140 interacts with options management component 1000 via step 2044 and proceeds to step 2805. If, at step 2805, user 140 attempts to interact with EPS management component 1050, then user 140 proceeds to step 2810; otherwise, user 140 proceeds to step 2815. If, at step 2810, user 140 has sufficient assigned rights 550, then user 140 proceeds to step 2895; otherwise, user 140 proceeds to step 2815. Via step 2815, user 140 can view digital signature settings 1009. Via step 2820, user 140 attempts to edit digital signature settings 1009. If, at step 2825, user 140 has sufficient assigned rights 550, then user 140 proceeds to step 2835; otherwise, user 140 proceeds to step 2830.

Via step 2835 user 140 can edit digital signatures settings 1009, wherein digital signatures settings 1009 comprises selectively editing one of the following to comprise either “Active” or “Disabled”: digital signature template storage 1010, digital signature SOX document storage 1011, digital signature governance document storage 1012, digital signature process automation 1013, digital signature activity management 1014, digital signature activity supervision 1015, digital signature edit company document 1016, digital signature edit training document 1017, digital signature glossary term 1018, digital signature loss event management 1019, digital signature risk management 1020, digital signature risk mitigation 1021, digital signature process entry update 1022, digital signature process creation 1023, digital signature deficiency creation 1024, digital signature SOX control 1025, digital signature governance control 1026, digital signature competency acknowledgement 1027 and/or digital signature competency updates 1028. Via step 2830, user 140 can selectively proceed to step 2815 or step 2000.

Turning to FIGS. 1, 5, 8, 10 and 24, from step 2895 user 140 proceeds to step 2900. Via step 2900, user 140 selectively sends email 905 and views EPS job list 1080, and subsequently user 140 proceeds to step 2905. If, at step 2905, user 140 elects to delete EPS job 1055, then user 140 proceeds to step 2910; otherwise, user 140 proceeds to step 2920. If, at step 2920, user 140 elects to edit job 1055, then user 140 proceeds to step 2925; otherwise, user 140 proceeds to step 2935.

If, at step 2910, user 140 has sufficient assigned rights 550, then user 140 proceeds to step 2915; otherwise, user 140 proceeds to step 2920. Via step 2915, user 140 selectively sends email 905 and deletes EPS job 1055, and subsequently user 140 proceeds to step 2900.

If, at step 2925, user 140 has sufficient assigned rights 550, then user 140 proceeds to step 2930; otherwise, user 140 proceeds to step 2935. Via step 2930, user 140 selectively sends email 905 and edits EPS job 1055, wherein editing EPS job 1055 comprises editing, deleting and/or creating EPS job 1055, and subsequently user 140 proceeds to step 2935. Via step 2935, user 140 can selectively proceed to step 2000 or step 2895.

Turning to FIGS. 1, 3, 5, 10 and 25, user 140 proceeds from step 2054 to step 3000. Via step 3000, user 140 selectively sends email 905 and views whistle blower event list 1110, and subsequently user 140 proceeds to step 3005, wherein user 140 selects whistle blower event 1105. User 140 proceeds to step 3010, wherein if user 140 has sufficient assigned rights 550, then user 140 proceeds to step 3020; otherwise, user 140 proceeds to step 3015. Via step 3020, user 140 selectively sends email 905 and edits whistle blower event 1105, wherein editing whistle blower event 1105 comprises editing or creating whistle blower event 1105, and user 140 subsequently proceeds to step 3030. If, at step 3030, user 140 elects to delete whistle blower event 1105, then user 140 proceeds to step 3035; otherwise, user 140 proceeds to step 3015. If, at step 3035, user 140 has sufficient assigned rights 550, then user 140 proceeds to step 3040; otherwise, user 140 proceeds to step 3015. Via step 3040, user 140 selectively sends email 905, deletes whistle blower event 1105 and subsequently proceeds to step 3015. Via step 3015, user 140 elects to proceed to step 2054 or step 2000.

Turning to FIGS. 1, 3, and 26, via step 3100 user 140 is asked questionnaire 1120 by whistle blower management component 1100. Via step 3105, user 140 provides information 1115 in answer to questionnaire 1120. Via step 3110, whistle blower management component 1100 determines whether to proceed to step 3115 or step 3120, wherein via step 3115 whistle blower management component 1100 creates whistle blower event 1105. In a preferred embodiment EPS job 1055 initiates step 3100.

Turning to FIGS. 1, 3, 5, 6, 7 and 27, from step 2064 user 140 subsequently proceeds to step 3200. Via step 3200, user 140 selectively sends email 905 and views incident list 1235, and user 140 subsequently proceeds to step 3205. Via step 3205, user 140 selectively sends email 905 and selects incident 1201. If, at step 3210, user 140 has sufficient assigned rights 550, then user 140 proceeds to step 3220; otherwise, user 140 proceeds to step 3215. Via step 3220, user 140 selectively sends email 905 and views incident 1201, and user 140 subsequently proceeds to step 3225. Via 3225, user 140 can elect whether to proceed to step 3270 or step 3240. If, at step 3270, user 140 has sufficient assigned rights 550, then user 140 proceeds to step 3230; otherwise, user 140 proceeds to step 3235. Via step 3230, user 140 selectively sends email 905 and edits incident 1201, wherein editing incident 1201 comprises editing, creating and/or deleting incident 1201. Via step 3235, user 140 elects whether to proceed to step 3220 or step 3215. Via step 3215, user 140 elects whether to proceed to step 2064 or step 2000.

Via step 3240, user 140 elects whether to associate incident 1201, wherein user 140 elects whether to proceed to step 3245 or step 3250. Via step 3245, user 140 can selectively generate email 905 and perform incident association 1230, wherein incident association 1230 comprises user 140 associating incident 1201 with risk 695, document 601, or control 715.

Via step 3250, user 140 elects whether to recommend control 715, wherein user 140 elects whether to proceed to step 3255 or step 3260. Via step 3255, user 140 can selectively generate email 905 and perform control recommendation 1245, wherein control recommendation 1245 comprises user 140 generating control 715. Via step 3260 user 140 elects whether to view incident 1201 at step 3220 or proceed to step 3265. Via step 3265 user 140 elects whether to proceed to step 2064 or to step 2000.

Turning to FIGS. 1, 3, 5 and 28, user 140 interacts with glossary management component 1300 via step 2074, and user 140 subsequently proceeds to step 3400. Via step 3400, user 140 elects whether to add unique word 1310 to glossary management component 1300, wherein user 140 elects whether to proceed to step 3405 or to step 3415. If, at step 3405, user 140 has sufficient assigned rights 550 to add unique word 1310, then user 140 proceeds to step 3410; otherwise, user 140 proceeds to step 3415. Via step 3410, user 140 selectively sends email 905 and adds unique word 1310 and word definition 1315 to glossary management component 1300, wherein unique word 1310 is associated with word definition 1315. Via step 3415, user 140 elects whether to view glossary 1305, wherein user 140 elects to proceed to step 3420 or step 2000. Via step 3420, user 140 selectively sends email 905 and views glossary 1305, and user 140 subsequently proceeds to step 3425. Via step 3425, user 140 elects whether to select unique word 1310, wherein user 140 elects whether to proceed to step 3430 or step 2000. Via step 3430, user 140 selectively sends email 905 and selects unique word 1310 and word definition 1315.

Via step 3435, user 140 elects whether to edit unique word 1310, wherein user 140 elects to proceed to step 3440 or step 3420. If, at step 3440, user 140 has sufficient assigned rights 550, then user 140 proceeds to step 3445; otherwise, user 140 proceeds to step 3420. Via step 3445, user 140 selectively sends email 905 and edits unique word 1310, and then proceeds to step 3415.

Turning now to FIGS. 1, 5, 13, 17, 18, 23, 24 and 28, if user 140 is interacting with organization management system 100 under the assigned rights 550 of system administrator role 810, then, at step 2012 user 140 will proceed to step 2014, at step 2042 user 140 will proceed to step 2044, at step 2072 user 140 will proceed to step 2074, at step 2230 user 140 will proceed to step 2240, at step 2260 user 140 will proceed to step 2270, at step 2810 user 140 will proceed to step 2895, at step 2825 user 140 will proceed to step 2835, at step 2910 user 140 will proceed to step 2915, at step 2925 user 140 will proceed to step 2930, at step 3405 user 140 will proceed to step 3410, and at step 3435 user 140 will proceed to step 3440.

Turning now to FIGS. 1, 5, 13, 17, 21 and 22, if user 140 is interacting with organization management system 100 under the assigned rights 550 of process activity manager role 812, then, at step 2032 user 140 will proceed to step 2034, at step 2620 user 140 will proceed to step 2625, at step 2635 user 140 will proceed to step 2640, at step 2650 user 140 will proceed to step 2655, and at step 2670, if user 140 is task owner 724 of task 720 then user 140 will proceed to step 2680.

Turning now to FIGS. 1, 5, 13, 19 and 20, if user 140 is interacting with organization management system 100 under the assigned rights 550 of audit committee role 814, then, at step 2465 user 140 will receive email 905 if document 601 relates to control 715, at step 2475 user 140 will receive email 905 if document 601 relates to control 715, at step 2505 user 140 will receive email 905 if document 601 relates to control 715, and at step 2515 user 140 will receive email 905 if document 601 relates to control 715.

Turning now to FIGS. 1, 5, 13, 18-21, 23-25, 27 and 28, if user 140 is interacting with organization management system 100 under the assigned rights 550 of read only role 816, then user 140 will never access step 2220, step 2240, step 2270, step 2425, step 2435, step 2445, step 2455, step 2465, step 2475, step 2485, step 2505, step 2515, step 2680, step 2835, step 2915, step 2930, step 3040, step 3220, step 3405 or step 3445.

Turning now to FIGS. 1, 5, 13, 17-25, 27 and 28, if user 140 is interacting with organization management system 100 under the assigned rights 550 of SOX compliance role 820, SOX tester role 824 or SOX evaluator role 826, then, at step 2012 user 140 will proceed to step 2014, at step 2022 user 140 will proceed to step 2014, at step 2032 user 140 will proceed to step 2014, at step 2042 user 140 will proceed to step 2014, at step 2052 user 140 will proceed to step 2014, at step 2062 user 140 will proceed to step 2014, at step 2072 user 140 will proceed to step 2014, at step 2210 user 140 will proceed to step 2215, at step 2230 user 140 will proceed to step 2220, at step 2260 user 140 will proceed to step 2250, at step 2400 user 140 will proceed to step 2405, at step 2410 user 140 will proceed to step 2415, at step 2490 user 140 will proceed to step 2495, at step 2520 user 140 will proceed to step 2525, at step 2605 user 140 will proceed to step 2610, at step 2620 user 140 will proceed to step 2625, at step 2635 user 140 will proceed to step 2640, at step 2650 user 140 will proceed to step 2655, at step 2670 user 140 will proceed to step 2675, at step 2825 user 140 will proceed to step 2830, at step 2910 user 140 will proceed to step 2920, at step 2925 user 140 will proceed to step 2935, at step 3035 user 140 will proceed to step 3015, at step 3270 user 140 will proceed to step 3220, at step 3405 user 140 will proceed to step 3415, at step 3435 user 140 will proceed to step 3420.

Turning now to FIGS. 1, 5, 13, 17-25, 27 and 28, if user 140 is interacting with organization management system 100 under the assigned rights 550 of lead auditor role 828, then, at step 2012 user 140 will proceed to step 2014, at step 2022 user 140 will proceed to step 2014, at step 2032 user 140 will proceed to step 2014, at step 2042 user 140 will proceed to step 2014, at step 2052 user 140 will proceed to step 2014, at step 2062 user 140 will proceed to step 2014, at step 2072 user 140 will proceed to step 2014, at step 2210 user 140 will proceed to step 2215, at step 2230 user 140 will proceed to step 2240, at step 2260 user 140 will proceed to step 2270, at step 2400 user 140 will proceed to step 2405, at step 2410 user 140 will proceed to step 2415, at step 2420 user 140 will proceed to step 2425, at step 2430 user 140 will proceed to step 2435, at step 2440 user 140 will proceed to step 2445, at step 2450 user 140 will proceed to step 2455, at step 2460 user 140 will proceed to step 2465, at step 2470 user 140 will proceed to step 2475, at step 2480 user 140 will proceed to step 2485, at step 2490 user 140 will proceed to step 2495, at step 2500 user 140 will proceed to step 2515, at step 2510 user 140 will proceed to step 2515, at step 2520 user 140 will proceed to step 2515, at step 2530 user 140 will proceed to step 2515, at step 2605 user 140 will proceed to step 2610, at step 2620 user 140 will proceed to step 2625, at step 2635 user 140 will proceed to step 2640, at step 2650 user 140 will proceed to step 2655, at step 2670 user 140 will proceed to step 2680, at step 2810 user 140 will proceed to step 2895, at step 2825 user 140 will proceed to step 2835, at step 2910 user 140 will proceed to step 2915, at step 2925 user 140 will proceed to step 2930, at step 3035 user 140 will proceed to step 3040, at step 3270 user 140 will proceed to step 3230, at step 3405 user 140 will proceed to step 3410, at step 3435 user 140 will proceed to step 3440.

Turning now to FIGS. 1, 5, 13, 17-25, 27 and 28, if user 140 is interacting with organization management system 100 under the assigned rights 550 of SOX audit role 822, then, at step 2012 user 140 will proceed to step 2014, at step 2022 user 140 will proceed to step 2014, at step 2032 user 140 will proceed to step 2014, at step 2042 user 140 will proceed to step 2014, at step 2052 user 140 will proceed to step 2014, at step 2062 user 140 will proceed to step 2014, at step 2072 user 140 will proceed to step 2014, at step 2210 user 140 will proceed to step 2215, at step 2230 user 140 will proceed to step 2220, at step 2260 user 140 will proceed to step 2250, at step 2400 user 140 will proceed to step 2405, at step 2410 user 140 will proceed to step 2415, at step 2490 user 140 will proceed to step 2495, at step 2520 user 140 will proceed to step 2525, at step 2605 user 140 will proceed to step 2610, at step 2620 user 140 will proceed to step 2625, at step 2635 user 140 will proceed to step 2640, at step 2650 user 140 will proceed to step 2655, at step 2670 user 140 will proceed to step 2680, at step 2825 user 140 will proceed to step 2830, at step 2910 user 140 will proceed to step 2920, at step 2925 user 140 will proceed to step 2935, at step 3035 user 140 will proceed to step 3015, at step 3270 user 140 will proceed to step 3220, at step 3405 user 140 will proceed to step 3415, at step 3435 user 140 will proceed to step 3420, and at step 2210 user 140 will proceed to step 2010.

Turning now to FIGS. 1, 5, 13, 17-25, 27 and 28, if user 140 is interacting with organization management system 100 under the assigned rights 550 of governance preparation role 830, governance tester role 832 or governance evaluator role 834, then, at step 2012 user 140 will proceed to step 2014, at step 2022 user 140 will proceed to step 2014, at step 2032 user 140 will proceed to step 2014, at step 2042 user 140 will proceed to step 2014, at step 2052 user 140 will proceed to step 2014, at step 2062 user 140 will proceed to step 2014, at step 2072 user 140 will proceed to step 2014, at step 2210 user 140 will proceed to step 2215, at step 2230 user 140 will proceed to step 2220, at step 2260 user 140 will proceed to step 2250, at step 2400 user 140 will proceed to step 2405, at step 2410 user 140 will proceed to step 2415, at step 2420 user 140 will proceed to step 2425, at step 2430 user 140 will proceed to step 2435, at step 2440 user 140 will proceed to step 2445, at step 2450 user 140 will proceed to step 2455, at step 2460 user 140 will proceed to step 2465, at step 2470 user 140 will proceed to step 2475, at step 2480 user 140 will proceed to step 2485, at step 2490 user 140 will proceed to step 2495, at step 2500 user 140 will proceed to step 2405, at step 2510 user 140 will proceed to step 2515, at step 2520 user 140 will proceed to step 2525, at step 2530 user 140 will proceed to step 2535, at step 2605 user 140 will proceed to step 2610, at step 2620 user 140 will proceed to step 2625, at step 2635 user 140 will proceed to step 2640, at step 2650 user 140 will proceed to step 2655, at step 2670 user 140 will proceed to step 2680, at step 2825 user 140 will proceed to step 2830, at step 2910 user 140 will proceed to step 2920, at step 2925 user 140 will proceed to step 2935, at step 3035 user 140 will proceed to step 3015, at step 3270 user 140 will proceed to step 3220, at step 3405 user 140 will proceed to step 3415, at step 3435 user 140 will proceed to step 3420, and at step 2210 user 140 will proceed to step 2010.

Turning now to FIGS. 1, 5, 13, 17-25, 27 and 28, if user 140 is interacting with organization management system 100 under the assigned rights 550 of entity wide privileges 842, wherein user 140 is associated with entity 175, at step 2012 user 140 will proceed to step 2014, at step 2022 user 140 will proceed to step 2014, at step 2032 user 140 will proceed to step 2014, at step 2042 user 140 will proceed to step 2014, at step 2052 user 140 will proceed to step 2014, at step 2062 user 140 will proceed to step 2014, at step 2072 user 140 will proceed to step 2014, at step 2210 user 140 will proceed to step 2215, at step 2230 user 140 will proceed to step 2240, at step 2260 user 140 will proceed to step 2270, at step 2400 user 140 will proceed to step 2405 if document 601 is associated with entity 175, at step 2410 user 140 will proceed to step 2415 if document 601 is associated with entity 175, at step 2420 user 140 will proceed to step 2425, at step 2430 user 140 will proceed to step 2435, at step 2440 user 140 will proceed to step 2445, at step 2450 user 140 will proceed to step 2455, at step 2460 user 140 will proceed to step 2465 if document 601 is associated with entity 175, at step 2470 user 140 will proceed to step 2475 if document 601 is associated with entity 175, at step 2480 user 140 will proceed to step 2485, at step 2490 user 140 will proceed to step 2495, at step 2500 user 140 will proceed to step 2515, at step 2510 user 140 will proceed to step 2515, at step 2520 user 140 will proceed to step 2515 if document 601 is associated with entity 175, at step 2530 user 140 will proceed to step 2515 if document 601 is associated with entity 175, at step 2605 user 140 will proceed to step 2610, at step 2620 user 140 will proceed to step 2625 if project 705 is associated with entity 175, at step 2635 user 140 will proceed to step 2640 if phase 710 is associated with entity 175, at step 2650 user 140 will proceed to step 2655 if control 715 is associated with entity 175, at step 2670 user 140 will proceed to step 2680 if task 720 is associated with entity 175, at step 2910 user 140 will proceed to step 2915 if EPS job 1055 is associated with entity 175, at step 2925 user 140 will proceed to step 2930 if EPS job 1055 is associated with entity 175, at step 3035 user 140 will proceed to step 3040 if whistle blower event 1105 is associated with entity 175, at step 3210 user 140 will proceed to step 3220 if incident 1201 is associated with entity 175, at step 3270 user 140 will proceed to step 3230 if incident 1201 is associated with entity 175, at step 3405 user 140 will proceed to step 3410 if unique word 1310 is associated with entity 175, and at step 3435 user 140 will proceed to step 3440 if unique word 1310 is associated with entity 175.

Turning now to FIGS. 1, 5, 13, 17 and 22, if user 140 is interacting with organization management system 100 under the assigned rights 550 of sub assignment privileges 844, at step 2032 user 140 will proceed to step 2014, and at step 2680 user 140 may change task owner 724 of task 720 from user 140 to second user 145.

Turning now to FIGS. 1, 2, 5, 13, and 29, organization optimization system 100 audits user 140 via process 4000. Organization optimization system 100 proceeds to step 4005, wherein organization optimization system 100 selects user 140 at step 4005. Via step 4010, organization optimization system 100 determines if user 140 has assigned requirements 555 of competency requirement 852, wherein organization optimization system 100 selectively proceeds to step 4020 and wherein second user 145 audits user 140, and wherein auditing user 140 preferably comprises checking to see if user 140 have added, edited or certified that it is accurate.

Turning now to FIGS. 1, 5, 13, 19 and 20, if user 140 has assigned requirements 555 of notification requirement 854, then, at step 2425 organization optimization system 100 will send user 140 email 905 if risk 1240 is associated with control 710, at step 2445 organization optimization system 100 will send user 140 email 905 if improvement 615 is associated with control 710, at step 2465 organization optimization system 100 will send user 140 email 905 if document 601 is associated with control 710, at step 2475 organization optimization system 100 will send user 140 email 905 if document 601 is associated with control 710, at step 2485 organization optimization system 100 will send user 140 email 905 if document 601, task 720, control 715, phase 710 or project 705 is associated with control 710, at step 2505 organization optimization system 100 will send user 140 email 905 if document 601 is associated with control 710, and at step 2515 organization optimization system 100 will send user 140 email 905 if document 601 is associated with control 710.

Turning to FIGS. 1, 3, 4, 5 and 11, user 140 selectively sends email 905, wherein email 905 comprises unique key 910. Unique key 910 is associated with session 200, wherein user 140 may utilize unique key 910 to navigate to session 200 when unique key 910 was generated. For example, if user 140 generates unique key 910 while editing document 601, when user 140 later utilizes unique key 910 then organization optimization system 100 will navigate session 200 back to editing document 601. In another example, if user 140 generates unique key 910 while viewing task 720 in project 705, when user 140 later utilizes unique key 910 then organization optimization system 100 will navigate session 200 back to viewing task 720 in project 705. In yet another example, if user 140 generates unique key 910 while viewing incident 1201 in incident management component 1200, when user 140 later utilizes unique key 910 then organization optimization system 100 will navigate session 200 back to viewing incident 1201 in incident management component 1200. In a preferred embodiment, organization optimization system 100 always provides the ability to send email 905 with unique key 915 (best shown FIG. 10).

Turning to FIGS. 1, 3, 6, 7, 19 and 20, if digital signature template storage 1010 comprises “Active”, then organization optimization system 100 stores digital signature 1005 when user 140 stores or edits document template 602 at step 2465, step 2475, step 2505 or step 2515.

Turning to FIGS. 1, 3, 6, 7, 19 and 20, if digital signature SOX document storage 1011 comprises “Active”, then organization optimization system 100 stores digital signature 1005 when user 140 edits, creates or deletes SOX document 603 at step 2465, step 2475, step 2505 or step 2515.

Turning to FIGS. 1, 3, 6, 7, 19 and 20, if digital signature governance document storage 1012 comprises “Active”, then organization optimization system 100 will store digital signature 1005 when user 140 edits, creates or deletes governance document 604 at step 2465, step 2475, step 2505 or step 2515.

Turning to FIGS. 1, 3, 6, 7 and 19, if digital signature process automation 1013 comprises “Active”, then organization optimization system 100 will store digital signature 1005 when user 140 sets process automation 610 at step 2435.

Turning to FIGS. 1, 3, 7, 11 and 22, if digital signature activity management 1014 comprises “Active”, then organization optimization system 100 will store digital signature 1005 when user 140 changes task status 726 to “Completed” at step 2680.

Turning to FIGS. 1, 3, 7, 11 and 22, if digital signature activity supervision 1015 comprises “Active”, then organization optimization system 100 will store digital signature 1005 when user 140 creates, edits or deletes task 720 at step 2680.

Turning to FIGS. 1, 3, 6, 7, 19 and 20, if digital signature edit company document 1016 comprises “Active”, then organization optimization system 100 will store digital signature 1005 when user 140 edits, creates or deletes document 601 at step 2465, step 2475, step 2505 or step 2515.

Turning to FIGS. 1, 3, 6, 7, 19 and 20, if digital signature edit training document 1017 comprises “Active”, then organization optimization system 100 will store digital signature 1005 when user 140 edits, creates or deletes document 601 at step 2465, step 2475, step 2505 or step 2515, wherein document 601 is associated with training user 140 or second user 145.

Turning to FIGS. 1, 3, 7 and 28, if digital signature glossary term 1018 comprises “Active”, then organization optimization system 100 will store digital signature 1005 when user 140 edits, creates or deletes unique word 1310 or word definition 1315 at step 3410 or step 3445.

Turning to FIGS. 1, 3, 7, 9 and 27, if digital signature loss event management 1019 comprises “Active”, then organization optimization system 100 will store digital signature 1005 when user 140 performs incident association 1230 at step 3245.

Turning to FIGS. 1, 3, 7, 11 and 19, if digital signature risk management 1020 comprises “Active”, then organization optimization system 100 will store digital signature 1005 when user 140 records risk 695 at step 2425.

Turning to FIGS. 1, 3, 7, 9 and 27, if digital signature risk mitigation 1021 comprises “Active”, then organization optimization system 100 will store digital signature 1005 when user 140 sets control recommendation 1245 at step 3255.

Turning to FIGS. 1, 3, 7, 11 and 22, if digital signature process entry update 1022 comprises “Active”, then organization optimization system 100 will store digital signature 1005 when user 140 edits task 720 at step 2680.

Turning to FIGS. 1, 3, 7, 11 and 22, if digital signature process creation 1023 comprises “Active”, then organization optimization system 100 will store digital signature 1005 when user 140 creates task 720 at step 2680.

Turning to FIGS. 1, 3, 7, 9 and 27, if digital signature deficiency creation 1024 comprises “Active”, then organization optimization system 100 will store digital signature 1005 when user 140 performs control recommendation 1245 at step 3255.

Turning to FIGS. 1, 3, 6, 7 and 20, if digital signature SOX control 1025 comprises “Active”, then organization optimization system 100 will store digital signature 1005 when user 140 generates new document 645 at step 2505, generates new document version 650 at steps 2515, or when viewing or editing SOX document 603 at step 2465, step 2475, or step 2525.

Turning to FIGS. 1, 3, 6, 7 and 20, if digital signature governance control 1026 comprises “Active”, then organization optimization system 100 will store digital signature 1005 when user 140 generates new document 645 at step 2505, generates new document version 650 at step 2515, or when viewing or editing governance document 604 at step 2465, step 2475, or step 2525.

Turning to FIGS. 1, 3, 7, 13 and 29, if digital signature competency acknowledgement 1027 or digital signature competency updates 1028 comprise “Active”, then organization optimization system 100 will store digital signature 1005 when user 140 completes competency assessment 560 at step 4020.

In a preferred embodiment, nothing is ever deleted from organization optimization system 100, it is merely made inactive, and therefore inaccessible to user 140 or it is replaced with a newer version.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1) An organization optimization system comprising:
a server, wherein said organization optimization system is installed on and runs on said server;
a user management component, wherein said user management component comprises a plurality of user accounts, and wherein each of said plurality of user accounts comprises a username and a user password, and wherein each of said plurality of user accounts is associated with a user;
a login component, wherein said login component is communicatively connected to said user management component, and wherein said user utilizes a computer, and wherein said computer is communicatively connected to said server, and wherein said user utilizing said computer is allowed a session with said organization optimization system on said server only if said user provides said username and said password to said login component via said computer communicating said username and said password to said server;
a project management component, wherein said project management component is communicatively connected to said user management component, and wherein said project management component comprises a project, and wherein said project comprises a phase, and wherein said phase comprises a control, and wherein said control comprises a task, and wherein said task is associated with said user account; and
a document management component, wherein said document management component is communicatively connected to said project management component and said user management component, and wherein said document management component comprises at least one document.

2) The organization optimization system of claim 1, wherein said organization optimization system further comprises a role management component, wherein said role management component is communicatively connected to said user management component, and wherein said role management component comprises a plurality of roles, and wherein each of said users is associated with at least one of said plurality of roles.

3) The organization optimization system of claim 2, wherein said role management component further comprises a system administrator role, wherein if said user is interacting with said organization optimization system as said system administrator role, then said user may only interact with said user management component.

4) The organization optimization system of claim 3, wherein said role management component further comprises a read only role, wherein if said user is associated with said read only role then said user is restricted from making changes in said organization optimization system, and wherein said changes are selected from the group consisting of edits and additions.

5) The organization optimization system of claim 4, wherein said role management component further comprises a SOX compliance officer role, wherein if said user is interacting with said organization optimization system as said SOX compliance officer role then said user has a wide range of read write access within said organization optimization system.

6) The organization optimization system of claim 5, wherein said role management component further comprises a governance compliance officer role, wherein if said user is interacting with said organization optimization system as said governance compliance officer role, then said user has a wide range of read write access within said organization optimization system.

7) The organization optimization system of claim 6, said organization optimization system further comprising an email integration component, wherein said email integration component provides said user in said session the ability to generate a unique key, and wherein said unique key is representative of said user's session.

8) The organization optimization system of claim 7, wherein said organization optimization system further comprises an options management component, and wherein said options management component comprises a digital signature, and wherein said options management component is configurable to store said digital signature when said user edits said document, and wherein said options management component is further configurable to store said digital signature when said user carries out an operation selected from the group consisting of editing said task and competing said task.

9) The organization optimization system of claim 8, wherein said user selectively accesses an element selected from the group consisting of said project, said control, said phase, and said task, only if said user has sufficient rights to give said user said access.

10) The organization optimization system of claim 9, wherein said organization optimization system further comprises an incident management component, wherein said incident management component comprises at least one incident.

11) The organization optimization system of claim 10, wherein said user associates said incident with a particular selected from the group consisting of said control, said document, and a risk.

12) The organization optimization system of claim 11, wherein said incident management component provides said user the ability to view and edit every incident that is associated with said particular selected from the group consisting of said control, said document, and said risk.

13) The organization optimization system of claim 12, wherein said user posts said document to said document management component, and wherein said document relates to a function selected from the group consisting of training a second user and educating a second user.

14) The organization optimization system of claim 13, wherein said task is assigned to said user, and wherein said user is responsible for completing said task, and wherein said user edits the status of said task when said user completes said task.

15) The organization optimization system of claim 14, wherein said document management component further comprises an audit log, wherein said audit log is associated with an item selected from the group consisting of said project, said control, said phase, said task, and said document, and wherein said audit log comprises a history of said user's activity with respect to said item selected from the group consisting of said project, said control, said phase, said task, and said document.

16) An organization optimization system comprising a server, wherein said organization optimization system is installed on and runs on said server, and wherein a user utilizes a computer to interact with said organization optimization system, and wherein said computer and said server are communicatively connected, said organization optimization system further comprising:
a user management component, wherein said user management component comprises a plurality of user accounts and user passwords, and wherein each of said plurality of user accounts is associated with its respective user password;
a project management component, wherein said project management component is communicatively connected to said user management component;
a document management component, wherein said document management component is communicatively connected to said project management component and said user management component, and wherein said document management component comprises at least one document;
a role management component, wherein said role management component is communicatively connected to said user management component, and wherein said role management component comprises a plurality of roles, and wherein every user is associated with at least of said plurality of roles; and
an email management component, wherein said email management component provides said user in a session the ability to send an email with a unique key, wherein said unique key is representative of said user's session.

17) The organization optimization system of claim 16, wherein said organization optimization system further comprises an options management component, and wherein said options management component is configurable to store a digital signature when said user edits said document, and wherein said digital signature is associated with said user, and wherein said user is assigned rights to said organization optimization system, and wherein said user is granted access consistent with said assigned rights.

18) The organization optimization system of claim 17, wherein said project management component comprises a project, and wherein said project comprises a phase, and wherein said phase comprises a control, and wherein said control comprises a task, and wherein said task is associated with said user.

19) The organization optimization system of claim 18, wherein said organization optimization system further comprises an incident management component, wherein said incident management component comprises an incident, and wherein said user selectively associates said incident with a particular selected from the group consisting of said control, said document, and a risk, and wherein said incident management component provides said user the ability to view and edit said incident that is associated with said particular selected from the group consisting of said control, said document, and said risk.

20) The organization optimization system of claim 19, wherein said task is associated with and assigned to said user, and wherein said user is responsible for completing said task, and wherein said user will edit the status of said task when said user completes said task, and wherein said document management component further comprises an audit log, wherein said audit log is associated with an element selected from the group consisting of said project, said control, said phase, said task, and said document, and wherein said audit log comprises a history of said user's activity with respect to said element selected from the group consisting of said project, said control, said phase, said task, and said document.
